(19) United States
(12) Patent Application Publication
(10) Pub. No.: US 2024/0414797 A1
(43) Pub. Date: Dec. 12, 2024

(54) METHOD FOR RELAY COMMUNICATION, INITIATING TERMINAL AND RELAY TERMINAL

(71) Applicant: GUANGDONG OPPO MOBILE TELECOMMUNICATIONS CORP., LTD., Dongguan (CN)

(72) Inventors: Yali GUO, Dongguan (CN); Fei LU, Dongguan (CN)

(21) Appl. No.: 18/811,197

(22) Filed: Aug. 21, 2024

Related U.S. Application Data
(63) Continuation of application No. PCT/CN2022/081688, filed on Mar. 18, 2022.

(51) Int. Cl. H04W 76/15; H04L 61/50; H04L 101/622

(52) U.S. Cl. CPC H04W 76/15; H04L 61/50; H04L 2101/622

(57) ABSTRACT

A method for relay communication, an initiating terminal, a relay terminal, and a target terminal are disclosed. The method includes the following. The initiating terminal determines, according to whether a first target connection has been established between the initiating terminal and the relay terminal, whether to use the first target connection for communication between the initiating terminal and the target terminal.

### CROSS-REFERENCE TO RELATED APPLICATION(S)

This application is a continuation of International Application No. PCT/CN2022/081688, filed Mar. 18, 2022, the entire disclosure of which is incorporated herein by reference.

### TECHNICAL FIELD

This disclosure relates to the field of communication, and in particularly to a method for relay communication, an initiating terminal, a relay terminal, and a target terminal.

### BACKGROUND

In some scenarios, an initiating terminal with proximity-based services (ProSe) capability can interact with a target terminal via a relay terminal with ProSe capability. Specifically, a link between the initiating terminal and the relay terminal and a link between the relay terminal and the target terminal are established for communication between the initiating terminal and the target terminal.

When the number of terminals communicating via the relay terminal increases, a corresponding link needs to be established for each initiating terminal and each target terminal, and thus there are lots of links, which increases the processing complexity of the relay terminal. In addition, since the number of links that the relay terminal can process is limited, the number of terminals communicating via the relay terminal is also limited. Therefore, how to improve relay communication performance is an urgent problem to be solved.

### SUMMARY

In a first aspect, a method for relay communication is provided. The method for relay communication includes the following. An initiating terminal determines, according to whether a first target connection has been established between the initiating terminal and a relay terminal, whether to use the first target connection for communication between the initiating terminal and a target terminal.

In a second aspect, an initiating terminal is provided. The initiating terminal includes a memory configured to store a computer program; and a processor configured to invoke and execute the computer program stored in the memory to determine, according to whether a first target connection has been established between the initiating terminal and a relay terminal, whether to use the first target connection for communication between the initiating terminal and a target terminal.

In a third aspect, a relay terminal is provided. The relay terminal includes a memory configured to store a computer program; and a processor configured to invoke and execute the computer program stored in the memory to: determine, according to whether a second target connection has been established between the relay terminal and a target terminal, whether to use the second target connection for communication between an initiating terminal and the target terminal.

### BRIEF DESCRIPTION OF THE DRAWINGS

FIG. 1 is a schematic diagram of a communication system architecture provided in embodiments of the present disclosure.

FIG. 2 is a schematic diagram illustrating interaction in establishing PC5 connections between user equipment (UEs).

FIG. 3 is a schematic diagram illustrating communication between two UEs via a relay UE.

FIG. 4 is a schematic diagram illustrating communication between UEs via a relay UE.

FIG. 5 is a schematic diagram of a method for relay communication provided in embodiments of the present disclosure.

FIG. 6 is a schematic diagram of another method for relay communication provided in embodiments of the present disclosure.

FIG. 7 is a schematic diagram of yet another method for relay communication provided in embodiments of the present disclosure.

FIG. 8 is a schematic diagram illustrating interaction in a method for relay communication provided in embodiments of the present disclosure.

FIG. 9 is a schematic diagram illustrating interaction in another method for relay communication provided in embodiments of the present disclosure.

FIG. 10 is a schematic diagram illustrating interaction in yet another method for relay communication provided in embodiments of the present disclosure.

FIG. 11 is a schematic block diagram of an initiating terminal provided in embodiments of the present disclosure.

FIG. 12 is a schematic block diagram of a relay terminal provided in embodiments of the present disclosure.

FIG. 13 is a schematic block diagram of a target terminal provided in embodiments of the present disclosure.

FIG. 14 is a schematic block diagram of a communication device provided in embodiments of the present disclosure.

FIG. 15 is a schematic block diagram of a chip provided in embodiments of the present disclosure.

FIG. 16 is a schematic block diagram of a communication system provided in embodiments of the present disclosure.

### DETAILED DESCRIPTION

The following will describe technical solutions of embodiments of the present disclosure with reference to the accompanying drawings in embodiments of the present disclosure. Apparently, embodiments described herein are merely some embodiments, rather than all embodiments, of the present disclosure. Based on the embodiments of the present disclosure, all other embodiments obtained by those of ordinary skill in the art without creative effort shall fall within the protection scope of the present disclosure.

The technical solutions of embodiments of the present disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a next-generation communication system, other communication systems, etc.

Generally speaking, a conventional communication system generally supports a limited quantity of connections and therefore is easy to implement. However, with the development of communication technology, a mobile communication system will not only support conventional communication but also support, for example, device-to-device (D2D) communication, machine-to-machine (M2M) communication, machine-type communication (MTC), vehicle-to-vehicle (V2V) communication, etc. The above communication systems are also applicable to embodiments of the present disclosure.

Optionally, the communication system in embodiments of the present disclosure can be applied to a carrier aggregation (CA) scenario, or can be applied to a dual connectivity (DC) scenario, or can be applied to a standalone (SA) network deployment scenario.

Embodiments of the present disclosure are not limited to the spectrum applicable to embodiments of the present disclosure. For example, embodiments of the present disclosure are applicable to licensed spectrum and unlicensed spectrum.

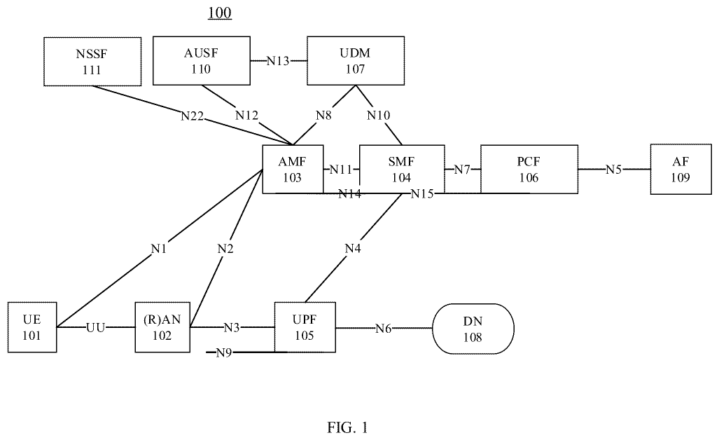

FIG. 1 exemplarily illustrates a schematic diagram of a communication system 100 applicable to the present disclosure. As illustrated in FIG. 1, the communication system 100 mainly includes a terminal device (i.e., user equipment, UE) 101, an access network (AN) or radio access network (RAN) device 102, an access and mobility management function (AMF) entity 103, a session management function (SMF) entity 104, a user plane function (UPF) entity 105, a policy control function (PCF) entity 106, a unified data management (UDM) entity 107, a data network (DN) 108, an application function (AF) entity 109, an authentication server function (AUSF) entity 110, and a network slice selection function (NSSF) entity 111.

Specifically, in the communication system 100, the UE 101 establishes an access stratum (AS) connection with the AN or RAN device 102 via a Uu interface to exchange AS messages and perform wireless data transmission, and the UE 101 establishes a non-access stratum (NAS) connection with the AMF entity 103 via an N1 interface to exchange NAS messages. The AN or RAN device 102 is connected to the AMF entity 103 via an N2 interface and to the UPF entity 105 via an N3 interface. Multiple UPF entities 105 are connected to each other via an N9 interface, and the UPF entity 105 is connected to the DN 108 via an N6 interface and to the SMF entity 104 via an N4 interface at the same time. The SMF entity 104 is connected to the PCF entity 106 via an N7 interface, to the UDM entity 107 via an N10 interface, and to AMF entity 103 via an N11 interface, and the SMF entity 104 controls the UPF entity 105 via the N4 interface. Multiple AMF entities 103 are connected to each other via an N14 interface, and the AMF entity 103 is connected to the UDM entity 107 via an N8 interface, to the AUSF entity 110 via an N12 interface, to the NSSF entity 111 via an N22 interface, and to the PCF entity 106 via an N15 interface. The PCF entity 106 is connected to the AF entity 109 via an N5 interface connected. The AUSF entity 110 is connected to UDM entity 107 via an interface N13.

In the communication system 100, the UDM entity 107 is a subscription database in the core network (CN) to store subscription data of a user in the 5G network. The AMF entity 103 has a mobility management function in the core network, and the SMF entity 104 has a session management function in the core network. In addition to performing mobility management on the UE 101, the AMF entity 103 is also responsible for forwarding messages related to session management between the UE 101 and the SMF entity 104. The PCF entity 106 has a policy management function in the core network, and is responsible for formulating policies related to mobility management, session management, charging, etc., for the UE 101. The UPF entity 105 has a user plane function in the core network, and performs data transmission with the external data network via the N6 interface and with the AN device 102 via the N3 interface. After the UE 101 accesses the 5G network via the Uu interface, a protocol data unit (PDU) session data connection between the UE 101 and the UPF entity 105 is established under the control of the SMF entity 104 to perform data transmission. The AMF entity 103 obtains user subscription data from the UDM entity 107 via the N8 interface and policy data from the PCF entity 106 via the N15 interface. The SMF entity 104 obtains user subscription data from the UDM entity 107 via the N10 interface and policy data from the PCF entity 106 via the N7 interface.

In addition, the communication system 100 also includes a network exposure function (NEF) entity. The NEF entity is used for interfacing with a third-party application server to transfer information between the core network node and a third-party application.

It can be noted that the communication system 100 is described by taking a 5G communication system as an example. Other 3GPP communication systems such as a 4G communication system or a future 3GPP communication system are also applicable to the present disclosure, which is not limited in the present disclosure.

It can be understood that in embodiments of the present disclosure, a device having a communication function in the network/system can be referred to as a communication device.

Embodiments of the present disclosure describe various embodiments in conjunction with the terminal device and the network device. The terminal device can also be referred to as user equipment, an access terminal, a subscriber unit, a subscriber station, a mobile station, a mobile platform, a remote station, a remote terminal, a mobile device, a user terminal, a terminal, a wireless communication device, a user agent or a user apparatus, etc. The terminal device can be a station (ST) in WLAN, and can be a cellular phone, a cordless phone, a session initiation protocol (SIP) phone, a wireless local loop (WLL) station, a personal digital assistant (PDA) device, a handheld device with a wireless communication capability, a computing device or other processing devices connected to a wireless modem, an in-vehicle device, a wearable device, and a next-generation communication system, such as a terminal device in the NR network or the terminal device in the future evolved public land mobile network (PLMN) network, etc.

By way of explanation rather than limitation, in embodiments of the present disclosure, the terminal device can also be a wearable device. The wearable device can also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

The AN device 102 can be a device for communicating with a mobile device, can be an access point (AP) in WLAN, a base transceiver station (BTS) in GSM or CDMA, or a base station (NodeB, NB) in WCDMA, or can be an evolutional Node B (eNB or eNodeB) in LTE, a relay station, an AP, a base station (e.g., gNB) in vehicle-mounted devices, wearable devices, and NR networks, a network device in the future evolved PLMN network, etc.

In embodiments of the present disclosure, the network device serves a cell, and the terminal device communicates with the network device on a transmission resource (for example, a frequency-domain resource or a spectrum resource) for the cell. The cell can be a cell corresponding to the network device (for example, a base station). The cell can belong to a macro base station, or can belong to a base station corresponding to a small cell. The small cell can include: a metro cell, a micro cell, a pico cell, a femto cell, and the like. These small cells are characterized by small coverage and low transmission power and are adapted to provide data transmission service with high-rate.

It can be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

It can be understood that, “indication” referred to in embodiments of the present disclosure can be a direct indication, can be an indirect indication, or can mean that there is an association relationship. For example, A indicates B can mean that A directly indicates B, for instance, B can be obtained according to A; can mean that A indirectly indicates B, for instance, A indicates C, and B can be obtained according to C; or can mean that there is an association relationship between A and B.

In the elaboration of embodiments of the present disclosure, the term

“correspondence” can mean that there is a direct or indirect correspondence between the two, can mean that there is an association between the two, can mean a relationship of indicating and indicated or configuring and configured, etc.

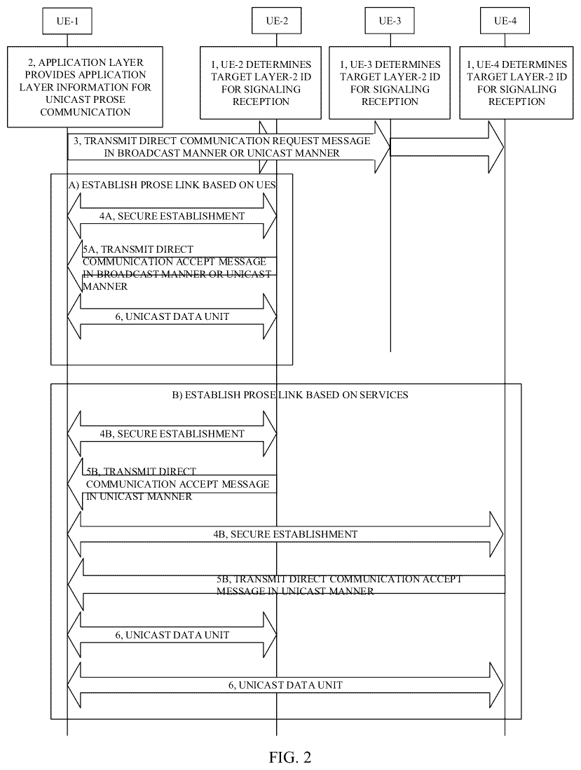

In some scenarios, a UE with proximity-based services (ProSe) capability can communicate directly with another UE with ProSe capability via a PC5 interface. FIG. 2 is a schematic diagram illustrating interaction in establishing PC5 connections between UEs.

As illustrated in FIG. 2, UE-1 is an initiating UE for connection establishment, and UE-2, UE-3, and UE-4 are target UEs for connection establishment.

Step 1, a target UE determines a target layer-2 identity (ID) for signaling reception. For example, UE-2 determines a target layer-2 ID for signaling reception, UE-3 determines a target layer-2 ID for signaling reception, and UE-4 determines a target layer-2 ID for signaling reception.

Step 2, an application layer of UE-1 provides application layer information for unicast ProSe communication.

Step 3, UE-1 transmits a direct communication request message in a broadcast or a unicast manner.

In some cases, UE-1 can initiate establishment of a ProSe link based on UEs. Taking UE-2 as an example, the following can be included.

Step 4a, secure establishment is performed between UE-1 and UE-2.

Step 5a, UE-2 transmits a direct communication accept message in the unicast manner.

Step 6a, a unicast data unit is transmitted between UE-1 and UE-2 via the established ProSe link.

In other cases, the UE-1 can initiate establishment of a ProSe link based on services. Taking establishment of a ProSe link based on services between UE-1 and UE-2 and establishment of a ProSe link based on services between UE-1 and UE-4 as examples, the following can be included.

Step 4b, secure establishment is performed between UE-1 and UE-2, and secure establishment is performed between UE-1 and UE-4.

Step 5b, UE-2 transmits a direct communication accept message in the unicast manner, and UE-4 transmits a direct communication accept message in the unicast manner.

Step 6b, a unicast data unit is transmitted between UE-1 and UE-2 via the established ProSe link, and a unicast data unit is transmitted between UE-1 and UE-4 via the established ProSe link.

In some scenarios, when two UEs with ProSe capability are far apart and cannot communicate with each other via a PC5 interface directly, communication between these two

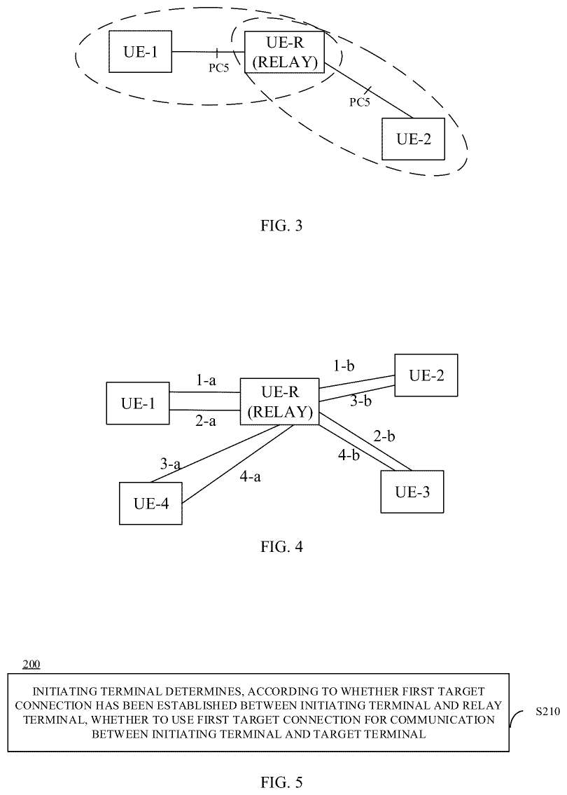

UEs can be relayed via a relay UE with ProSe capability. FIG. 3 is a schematic diagram illustrating service interaction via the relay UE.

As illustrated in FIG. 3, the relay UE can perform direct communication with UE-1 via a PC5 interface, and the relay UE can also perform direct communication with UE-2 via a PC5 interface, such that a service interaction between UE-1 and UE-2 can be achieved via the relay UE.

In related art, a method for communication between UEs via a relay UE (denoted as UE-R) is illustrated in FIG. 4. UE-1 establishes a separate link between UE-1 and UE-R for each target UE (e.g., UE-2 and UE-3). For example, link 1-a is used for communication between UE-1 and UE-2, and link 2-a is used for communication between UE-1 and UE-3. UE-4 also establishes a separate link between UE-4 and UE-R for each target UE. For example, link 3-a is used for communication between UE-4 and UE-2, and link 4-a is used for communication between UE-4 and UE-3.

Accordingly, for each initiating UE (e.g., UE-1 and UE-4), a separate link is also established between UE-R and the target UE. For example, link 1-b is used for communication between UE-1 and UE-2, link 3-b is used for communication between UE-4 and UE-2, link 2-b is used for communication between UE-1 and UE-3, and link 4-b is used for communication between UE-4 and UE-3. In this way, UE-R only needs to associate link 1-a with link 1-b to forward data between UE-1 and UE-2. Similarly, link 2-a can be associated with link 2-b to forward data between UE-1 and UE-3, link 3-a can be associated with link 3-b to forward data between UE-4 and UE-2, and link 4-a can be associated with link 4-b to forward data between UE-4 and UE-3.

However, when the number of UEs communicating via the relay UE increases, the number of links that need to be established increases accordingly, thereby increasing the processing complexity of the relay UE. In addition, since the number of links that the relay terminal can process is limited, the number of terminals that can communicate via the relay terminal is also limited.

For a better understanding of the technical solutions of embodiments of the present disclosure, the technical solutions of the present disclosure will be described in detail below in connection with embodiments. The following related art as an optional scheme can be arbitrarily combined with the technical solutions of embodiments of the present disclosure, which shall all belong to the protection scope of embodiments of the present disclosure. Embodiments of the present disclosure include at least some of the following.

FIG. 5 is a schematic diagram of a method 200 for relay communication according to embodiments of the present disclosure. As illustrated in FIG. 5, the method 200 includes the following.

S210, an initiating terminal determines, according to whether a first target connection has been established between the initiating terminal and a relay terminal, whether to use the first target connection for communication between the initiating terminal and a target terminal.

In some embodiments, the initiating terminal can be the UE 101 in the communication system as illustrated in FIG. 1. For the specific implementation of the initiating terminal, reference can be made to related descriptions of the embodiment illustrated in FIG. 1, which is not repeated herein.

It can be noted that in embodiments of the present disclosure, “connection” can be replaced with “link”, “path”, etc. For example, “first target connection” can be replaced with “first target link”, “second target connection” can be replaced with “second target link”, and “PC5 connection” can be replaced with “PC5 link”, which is not limited in the present disclosure.

In some embodiments, the initiating terminal has decided to communicate with the target terminal via the relay terminal.

In some embodiments, whether the first target connection has been established between the initiating terminal and the relay terminal includes: whether the first target connection has been established between the initiating terminal and the relay terminal.

In some embodiments, the first target connection is a direct communication connection between the initiating terminal and the relay terminal. For example, the first target connection is a PC5 connection between the initiating terminal and the relay terminal.

In other embodiments, the first target connection is a direct communication connection for a specific service between the initiating terminal and the relay terminal, where the specific service is a service to be transmitted between the initiating terminal and the target terminal.

That is, the connection between the initiating terminal and the relay terminal can be based on service or not based on service.

In some embodiments, whether the first target connection has been established between the initiating terminal and the relay terminal includes: whether the PC5 connection has been established between the initiating terminal and the relay terminal.

For example, in the case where the initiating terminal has a service to be transmitted to the target terminal, the initiating terminal can determine whether the PC5 connection has been established between the initiating terminal and the relay terminal. Optionally, in the case where the PC5 connection has been established between the initiating terminal and the relay terminal, the initiating terminal can determine that the first target connection has been established between the initiating terminal and the relay terminal. Otherwise, the initiating terminal can determine that the first target connection has not been established between the initiating terminal and the relay terminal.

In other embodiments, whether the first target connection has been established between the initiating terminal and the relay terminal includes: whether a PC5 connection for the service to-be-transmitted has been established between the initiating terminal and the relay terminal.

For example, in the case where the initiating terminal has the service to be transmitted to the target terminal, the initiating terminal can determine whether the PC5 connection for the service to-be-transmitted has been established between the initiating terminal and the relay terminal.

Optionally, in the case where the PC5 connection for the service to-be-transmitted has been established between the initiating terminal and the relay terminal, the initiating terminal can determine that the first target connection has been established between the initiating terminal and the relay terminal. Otherwise, the initiating terminal can determine that the first target connection has not been established between the initiating terminal and the relay terminal.

The method 200 for relay communication provided in embodiments of the present disclosure will be described in conjunction with Embodiment 1 and Embodiment 2 as follows.

### Embodiment 1:

In some embodiments of the present disclosure, operations at S210 include the following. In the case where the first target connection has been established between the initiating terminal and the relay terminal, the initiating terminal determines to use the first target connection for communication (or service interaction) between the initiating terminal and the target terminal, or reuses the first target connection for communication (or service interaction) between the initiating terminal and the target terminal.

Therefore, in embodiments of the present disclosure, in the case where the first target connection has been established between the initiating terminal and the relay terminal, the initiating terminal can reuse the first target connection to communicate with the target terminal instead of establishing a new connection for the target terminal, which is conducive to decreasing the number of connections for relay communication via the relay terminal and reducing the processing complexity of the relay terminal.

For ease of differentiation and illustration, the target terminal in embodiments of the present disclosure is referred to as a first target terminal, and the established first target connection is used for communication between the initiating terminal and a second target terminal. In other words, the initiating terminal can use the first target connection for communication between the initiating terminal and the first target terminal and reuse the first target connection for communication between the initiating terminal and the second target terminal. Alternatively, the initiating terminal can reuse the first target connection for communication between the initiating terminal and multiple target terminals. In other words, the first target connection can serve multiple target terminals.

In some embodiments of the present disclosure, the service to-be-transmitted is a service to be transmitted between the initiating terminal and the first target terminal.

In some embodiments of the present disclosure, the method 200 further includes the following. The initiating terminal transmits a first request message to the relay terminal, where the first request message is used for requesting to use the first target connection for communication between the initiating terminal and the target terminal, or the first request message is used for requesting to reuse the first target connection to transmit the service to-be-transmitted between the initiating terminal and the target terminal.

Correspondingly, the relay terminal receives the first request message from the initiating terminal.

For example, in the case where the first target connection has been established between the initiating terminal and the relay terminal, the initiating terminal transmits the first request message to the relay terminal.

For another example, in the case where the initiating terminal determines to use the first target connection for communication between the initiating terminal and the target terminal, the initiating terminal transmits the first request message to the relay terminal.

In some embodiments, the initiating terminal can reuse existing messages to realize the function of the first request message. For example, the initiating terminal uses a link modification request message to request to reuse the established connection. Alternatively, a new message can be introduced to realize the function of the first request message, and the present disclosure does not limit the specific implementation of the first request message.

For example, the first request message is the link modification request message, or a connection modification request message or a connection reuse request message can be introduced to reuse the established connection.

Optionally, the first request message can be used for modification of the established first target connection, for example, a new target terminal served by the first target connection can be added.

As an example, the first target connection is a connection from UE-1 to UE-R, and the first target connection is used for communication between UE-1 and UE-2, i.e., the initiating terminal is UE-1, the relay terminal is UE-R, and the target terminal is UE-2. When UE-1 also decides to communicate with UE-3 via UE-R, the first target connection can also be used, and thus the first target connection can be used for communication between UE-1 and UE-2 and communication between UE-1 and UE-3. In other words, the target terminal served by the first target connection is changed from UE-2 to UE-2 and UE-3.

In some embodiments, the first request message contains ID information of the target terminal or address information of the initiating terminal.

In some embodiments, by carrying the ID information of the target terminal in the first request message, the relay terminal can be notified of the target terminal corresponding to the relay communication of the first target connection reused, or be notified of the newly added target terminal served by the first target connection.

In some embodiments, the address information of the initiating terminal can be used by the relay terminal to determine to which terminal device the service to-be-transmitted is to be routed or forwarded or from which initiating terminal the service to-be-transmitted comes.

In some embodiments, the address information of the initiating terminal includes, but is not limited to, internet protocol (IP) address information of the initiating terminal and/or media access control (MAC) address information of the initiating terminal.

In some embodiments, the ID information of the target terminal can be used for identifying the target terminal. For example, the ID information of the target terminal can include, but is not limited to, an application layer ID and/or a link layer ID, e.g. a layer 2-ID, of the target terminal.

Optionally, the relay terminal can determine, according to the ID information of the target terminal, whether a second target connection has been established between the relay terminal and the target terminal, and thus the relay terminal can determine whether to reuse the second target connection, and the specific implementation will be described in method 300 below and is not repeated herein.

In some embodiments, the second target connection is a direct communication connection between the relay terminal and the target terminal. For example, the second target connection is a PC5 connection between the relay terminal and the target terminal.

In other embodiments, the second target connection is a direct communication connection for a specific service between the relay terminal and the target terminal, where the specific service is a service to be transmitted between the initiating terminal and the target terminal.

That is, the connection between the relay terminal and the target terminal can be based on service or not based on service.

Therefore, in some embodiments of the present disclosure, the initiating terminal can communicate with multiple target terminals via the first target connection, and/or the relay terminal can relay the services to-be-transmitted from multiple initiating terminals via the second target connection. As a result, for the relay terminal, how to differentiate the initiating terminals and/or the target terminals of the services to-be-transmitted so as to forward correct data is a problem to be solved.

In some embodiments, the relay terminal can forward or route data according to the address information of the initiating terminal and/or address information of the target terminal.

For example, when the first target connection serves multiple target terminals, the relay terminal can determine, according to the address information of the target terminal, to which target terminal the service to-be-transmitted is to be forwarded.

For another example, when the second target connection serves multiple initiating terminals, the relay terminal can determine, according to the address information of the initiating terminal, from which initiating terminal the service to-be-transmitted comes.

In some embodiments of the present disclosure, the method 200 further includes the following. The relay terminal transmits a first response message to the initiating terminal.

Correspondingly, the initiating terminal receives the first response message from the relay terminal, where the first response message is a response message to the first request message.

In some embodiments, the first response message indicates that the relay terminal determines to use the first target connection for communication between the initiating terminal and the target terminal. Alternatively, the first response message indicates that the relay terminal determines to reuse the first target connection to transmit the service to-be-transmitted between the initiating terminal and the target terminal.

That is, the relay terminal can notify the initiating terminal via the first response message, that the relay terminal determines to reuse the first target connection.

In some embodiments, the relay terminal can reuse existing messages to realize the function of the first response message. For example, the relay terminal uses a link modification accept message to acknowledge to reuse the established connection. Alternatively, the relay terminal can introduce a new message to realize the function of the first response message, and the present disclosure does not limit the specific implementation of the first response message.

For example, the first response message is the link modification accept message, or a connection modification accept message or a connection reuse accept message can be introduced to reuse the established connection.

Optionally, the first response message can indicate that the relay terminal accepts a modification to the established first target connection. For example, the relay terminal accepts addition of a new target terminal served by the first target connection.

In some embodiments, the first response message contains the address information of the target terminal.

That is, the initiating terminal can obtain the address information of the target terminal from the first response message.

In some embodiments, the address information of the target terminal can be used by the relay terminal to determine to which terminal device the service to-be-transmitted is to be routed or forwarded.

In some embodiments, the address information of the target terminal includes, but is not limited to, IP address information of the target terminal and/or MAC address information of the target terminal.

It can be understood that embodiments of the present disclosure do not limit a manner in which the relay terminal obtains the address information of the target terminal, and the manner for obtaining the address information of the target terminal will be described below in connection with specific embodiments, which is not limited in the present disclosure.

In some implementations, the address information of the target terminal is obtained by the relay terminal from the target terminal.

For example, the address information of the target terminal is obtained from a third response message and/or a fourth response message from the target terminal, where the third response message indicates that the target terminal determines to use the second target connection for communication between the initiating terminal and the target terminal, and the fourth response message indicates that establishment of the second target connection is completed. The specific implementation of the third response message and the fourth response message will be described in method 300 and is not repeated herein.

In other implementations, the address information of the target terminal is negotiated by the relay terminal and the target terminal, or is allocated by the relay terminal to the target terminal.

For example, after the relay terminal receives the fourth response message from the target terminal, the relay terminal and the target terminal can perform IP address negotiation, such that the relay terminal can obtain the address information of the target terminal.

For another example, after the relay terminal receives the fourth response message from the target terminal, the relay terminal and the target terminal can perform an IP address allocation, such that the relay terminal can obtain the address information of the target terminal.

In another implementation, the address information of the target terminal is obtained by the relay terminal from context of the second target connection, stored in the relay terminal, between the relay terminal and the target terminal.

For example, in the case where the second target connection has been established between the relay terminal and the target terminal, the context of the second target connection can be stored in the relay terminal, and the context of the second target connection can include the address information of the target terminal.

In yet another implementation, the address information of the target terminal is obtained by the relay terminal in a secure interaction procedure between the relay terminal and the target terminal.

For example, in the case where the second target connection has not been established between the relay terminal and the target terminal, the relay terminal can initiate a procedure for establishing the second target connection in which the relay terminal and the target terminal can perform secure interaction, and the target terminal can transmit the address information of the target terminal to the relay terminal in the secure interaction procedure.

### Embodiment 2:

In other embodiments of the present disclosure, operations at S210 include the following. In the case where the first target connection has not been established between the initiating terminal and the relay terminal, the initiating terminal determines to establish the first target connection for communication between the initiating terminal and the target terminal.

Therefore, in embodiments of the present disclosure, in the case where the first target connection has not been established between the initiating terminal and the relay terminal, the initiating terminal can initiate a procedure for establishing the first target connection for communication between the initiating terminal and the target terminal.

In some embodiments of the present disclosure, the method 200 further includes the following. The initiating terminal transmits a second request message to the relay terminal, where the second request message is used for requesting to establish the first target connection.

Correspondingly, the relay terminal receives the second request message from the initiating terminal.

For example, in the case where the first target connection has not been established between the initiating terminal and the relay terminal, the initiating terminal transmits the second request message to the relay terminal.

For another example, in the case where the initiating terminal determines to establish the first target connection, the initiating terminal transmits the second request message to the relay terminal.

In some embodiments, the initiating terminal can reuse existing messages to realize the function of the second request message. For example, the initiating terminal uses a direct communication request message to request to establish a connection (i.e., the second request message can be the direct communication request message). Alternatively, the initiating terminal can introduce a new message to realize the function of the second request message, and the present disclosure does not limit the specific implementation of the second request message.

In some embodiments, the second request message contains at least one of: ID information of the initiating terminal, the ID information of the target terminal, the address information of the initiating terminal, or information of the service to-be-transmitted.

Optionally, the relay terminal can determine, according to the ID information of the initiating terminal and the ID information of the target terminal carried in the second request message, the initiating terminal and the target terminal served by the connection to-be-established.

Optionally, the relay terminal can determine, according to the ID information of the target terminal, whether the second target connection has been established between the relay terminal and the target terminal, and thus the relay terminal can determine whether to reuse the second target connection, and the specific implementation will be described in method 300 below and is not repeated herein.

Optionally, the address information of the initiating terminal can be used by the relay terminal to determine to which terminal device the service to-be-transmitted is to be routed or forwarded or from which initiating terminal the service to-be-transmitted comes.

Optionally, the information of the service to-be-transmitted is used by the relay terminal to determine whether a connection for the service to-be-transmitted has been established between the relay terminal and the target terminal, i.e., whether the second target connection has been established, such that the relay terminal can determine whether to reuse the second target connection.

In some embodiments, the ID information of the initiating terminal is used for identifying the initiating terminal. For example, the ID information of the initiating terminal can include, but is not limited to, an application layer ID and/or a link layer ID, e.g. a layer 2-ID, of the initiating terminal.

In some embodiments, the ID information of the target terminal is used for identifying the target terminal. For example, the ID information of the target terminal can include, but is not limited to, an application layer ID and/or a link layer ID, e.g. a layer 2-ID, of the target terminal.

In some embodiments, the address information of the initiating terminal includes, but is not limited to, IP address information of the initiating terminal and/or MAC address information of the initiating terminal.

In some embodiments, the information of the service to-be-transmitted includes, but is not limited to, at least one of: an application ID, a type, or a relay service code (RSC) of the service to-be-transmitted.

In some embodiments of the present disclosure, the method 200 further includes the following. The initiating terminal and the relay terminal perform the secure interaction procedure.

Optionally, the initiating terminal transmits the address information of the initiating terminal to the relay terminal in a secure interaction procedure between the initiating terminal and the relay terminal.

That is, the relay terminal can obtain the address information of the initiating terminal from the second request message, or can obtain the address information of the initiating terminal in the secure interaction procedure between the initiating terminal and the relay terminal.

In some embodiments of the present disclosure, the 200 includes the following. The relay terminal transmits a second response message to the initiating terminal.

Correspondingly, the initiating terminal receives the second response message from the relay terminal, where the second response message is a response message to the second request message.

In some embodiments, the second response message indicates that establishment of the first target connection is completed.

In some embodiments, the relay terminal can reuse existing messages to realize the function of the second response message. For example, the relay terminal uses a direct communication accept message to indicate that establishment of the connection is completed (i.e., the second response message can be the direct communication accept message). Alternatively, the relay terminal can introduce a new message to realize the function of the second response message, and the present disclosure does not limit the specific implementation of the second response message.

In some embodiments, the second response message contains the address information of the target terminal.

That is, the initiating terminal can obtain the address information of the target terminal from the second response message.

In some embodiments, regarding the relay terminal, for the manner for obtaining the address information of the target terminal, reference can be made to related descriptions of Embodiment 1 and is not repeated herein.

In summary, in embodiments of the present disclosure, the initiating terminal can execute a corresponding procedure for the service interaction between the initiating terminal and the target terminal according to whether the connection for the service to-be-transmitted between the initiating terminal and the target terminal has been established between the initiating terminal and the relay terminal.

For example, when the connection for the service to-be-transmitted has been established between the initiating terminal and the relay terminal, the procedure for reusing the connection described in Embodiment 1 can be performed.

For another example, when the connection for the service to-be-transmitted has not been established between the initiating terminal and the relay terminal, the procedure for establishing the connection described in Embodiment 2 can be performed.

Therefore, in embodiments of the present disclosure, the PC5 connection between the initiating terminal and the relay terminal can serve multiple target terminals, and the relay terminal routes data according to the address information of the target terminal. For example, the relay terminal forwards IP data according to the IP address of the target terminal. In this way, data transmitted to different target terminals via the same connection can be distinguished according to different IP addresses, which is conducive to avoiding establishment of a separate PC5 connection between the relay terminal and the initiating terminal for each target terminal. In other words, the connections between the initiating terminal and the relay terminal are not required to be in one-to-one mapping with the connections between the relay terminal and the target terminal, which is conducive to decreasing the number of connections for relay communication via the relay terminal and reducing the processing complexity of the relay terminal, thereby improving the performance of relay communication.

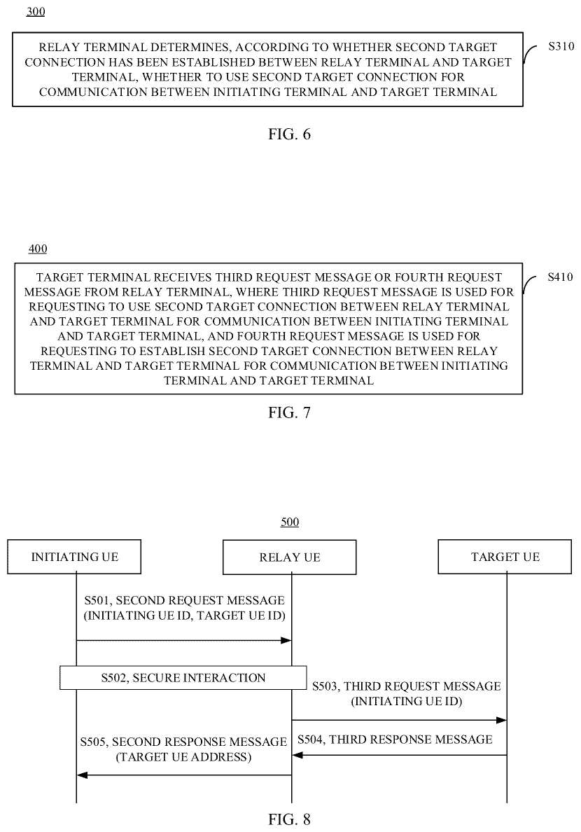

A method for relay communication according to an embodiment of the present disclosure is described in detail above in conjunction with FIG. 5 from the perspective of the initiating terminal, and a method for relay communication according to another embodiment of the present disclosure will be described in detail below in conjunction with FIG. 6 from the perspective of the relay terminal. It can be understood that the description on the relay device side and the description on the initiating terminal side correspond to each other, and for similar descriptions, reference can be made to the above, which is not repeated herein for brevity.

FIG. 6 is a schematic flowchart of a method 300 for relay communication according to another embodiment of the present disclosure. As illustrated in FIG. 3, the method 300 includes the following.

S310, a relay terminal determines, according to whether a second target connection has been established between the relay terminal and a target terminal, whether to use the second target connection for communication between an initiating terminal and the target terminal.

In some embodiments, the relay terminal can be the UE 101 in the communication system as illustrated in FIG. 1. For the specific implementation of the relay terminal, reference can be made to related descriptions of the embodiment illustrated in FIG. 1, which is not repeated herein.

It can be noted that in embodiments of the present disclosure, “connection” can be replaced with “link”, “path”, etc. For example, “first target connection” can be replaced with “first target link”, “second target connection” can be replaced with “second target link”, and “PC5 connection” can be replaced with “PC5 link”, which is not limited in the present disclosure.

In some embodiments, the initiating terminal has decided to communicate with the target terminal via the relay terminal.

In some embodiments, whether the second target connection has been established between the relay terminal and the target terminal includes: whether the second target connection has been established between the relay terminal and the target terminal.

In some embodiments, the second target connection is a direct communication connection between the relay terminal and the target terminal. For example, the second target connection is a PC5 connection between the relay terminal and the target terminal.

In other embodiments, the second target connection is a direct communication connection for a specific service between the relay terminal and the target terminal, where the specific service is a service to be transmitted between the initiating terminal and the target terminal.

That is, the connection between the relay terminal and the target terminal can be based on service or not based on service.

In some embodiments, whether the second target connection has been established between the relay terminal and the target terminal includes: whether the PC5 connection has been established between the relay terminal and the target terminal.

For example, in the case where the initiating terminal has a service to be transmitted to the target terminal or in the case where the relay terminal receives the first request message or the second request message from the initiating terminal, the relay terminal can determine whether the PC5 connection has been established between the relay terminal and the target terminal. For specific implementation of the first request message or the second request message, reference can be made to related descriptions of the method 200, which is not repeated herein for brevity.

Optionally, in the case where the PC5 connection has been established between the relay terminal and the target terminal, the relay terminal can determine that the second target connection has been established between the relay terminal and the target terminal. Otherwise, the relay terminal can determine that the second target connection has not been established between the relay terminal and the target terminal.

In other embodiments, whether the second target connection has been established between the relay terminal and the target terminal includes: whether the PC5 connection for the service to-be-transmitted has been established between the relay terminal and the target terminal.

For example, in the case where the initiating terminal has the service to be transmitted to the target terminal or in the case where the relay terminal receives the first request message or the second request message from the initiating terminal, the relay terminal can determine whether the PC5 connection for the service to-be-transmitted has been established between the relay terminal and the target terminal. For specific implementation of the first request message or the second request message, reference can be made to related descriptions of the method 200, which is not repeated herein for brevity.

Optionally, in the case where the PC5 connection for the service to-be-transmitted has been established between the relay terminal and the target terminal, the relay terminal can determine that the second target connection has been established between the relay terminal and the target terminal. Otherwise, the initiating terminal can determine that the second target connection has not been established between the relay terminal and the target terminal.

The method 300 for relay communication provided in embodiments of the present disclosure will be described in conjunction with Embodiment 3 and Embodiment 4 as follows.

### Embodiment 3:

In some embodiments of the present disclosure, operations at S310 include the following. In the case where the second target connection has been established between the relay terminal and the target terminal, the relay terminal determines to use the second target connection for communication (or service interaction) between the initiating terminal and the target terminal, or reuses the second target connection for communication (or service interaction) between the initiating terminal and the target terminal.

Therefore, in embodiments of the present disclosure, in the case where the second target connection has been established between the relay terminal and the target terminal, the relay terminal can reuse the second target connection for communication between the initiating terminal and the target terminal instead of establishing a new connection for the initiating terminal, which is conducive to decreasing the number of connections for relay communication via the relay terminal and reducing the processing complexity of the relay terminal.

For ease of differentiation and illustration, the initiating terminal in embodiments of the present disclosure is referred to as a first initiating terminal, and the established second target connection is used for communication between a second initiating terminal and the target terminal. In other words, the relay terminal can use the second target connection for communication between the first initiating terminal and the target terminal and reuse the first target connection for communication between the second initiating terminal and the target terminal. Alternatively, the relay terminal can reuse the second target connection for communication between multiple initiating terminals and the target terminal. In other words, the second target connection can serve multiple initiating terminals.

In some embodiments of the present disclosure, the service to-be-transmitted is a service to be transmitted between the first initiating terminal and the target terminal.

In some embodiments of the present disclosure, the method 300 further includes the following. The relay terminal transmits a third request message to the target terminal, where the third request message is used for requesting to use the second target connection for communication between the initiating terminal and the target terminal.

Correspondingly, the target terminal receives the third request message from the relay terminal.

For example, in the case where the second target connection has been established between the relay terminal and the target terminal, the relay terminal transmits the third request message to the target terminal.

For another example, in the case where the relay terminal determines to use the second target connection for communication between the initiating terminal and the target terminal, the relay terminal transmits the third request message to the target terminal.

In some embodiments, the relay terminal can reuse existing messages to realize the function of the third request message. For example, the relay terminal uses a link modification request message to request to reuse the established connection. Alternatively, the relay terminal can introduce a new message to realize the function of the third request message, and the present disclosure does not limit the specific implementation of the third request message.

For example, the third request message is a link modification request message, or a connection modification request message or a connection reuse request message can be introduced to reuse the established connection.

Optionally, the third request message can be used for modification of the established second target connection, for example, a new initiating terminal served by the second target connection can be added.

As an example, the second target connection is a connection from UE-R to UE-4, and the second target connection is used for communication between UE-5 and UE-4. When UE-6 also decides to communicate with UE-4 via UE-R, the second target connection can also be used, and thus the second target connection can be used for communication between UE-5 and UE-4 and communication between UE-6 and UE-4. In other words, the initiating terminal served by the second target connection is changed from UE-5 to UE-5 and UE-6.

In some embodiments, the third request message contains ID information of the initiating terminal and/or address information of the initiating terminal.

In some embodiments, by carrying the ID information of the initiating terminal in the third request message, the relay terminal can be notified of the initiating terminal corresponding to the relay communication of the second target connection reused, or be notified of the newly added initiating terminal served by the second target connection.

In some embodiments, the address information of the initiating terminal can be used by the relay terminal to determine to which terminal device the service to-be-transmitted is to be routed or forwarded or from which initiating terminal the service to-be-transmitted comes.

In some embodiments, the ID information of the initiating terminal is used for identifying the initiating terminal. For example, the ID information of the initiating terminal can include, but is not limited to, an application layer ID and/or a link layer ID, e.g. a layer 2-ID, of the initiating terminal.

It can be understood that embodiments of the present disclosure do not limit a manner in which the relay terminal obtains the ID information of the initiating terminal, and the manner for obtaining the ID information of the initiating terminal will be described below in connection with specific embodiments, which is not limited in the present disclosure.

In some implementations, the ID information of the initiating terminal is obtained by the relay terminal from the initiating terminal.

For example, the ID information of the initiating terminal is obtained from a first request message and/or a second request message from the initiating terminal. For the specific implementations of the first request message and the second request message, reference can be made to related descriptions of method 200 and is not repeated herein for brevity.

In other implementations, the ID information of the initiating terminal is obtained by the relay terminal from context of the first target connection, stored in the relay terminal, between the relay terminal and the initiating terminal.

For example, in the case where the first target connection has been established between the initiating terminal and the relay terminal, the context of the first target connection can be stored in the relay terminal, and the context of the first target connection can include the ID information of the initiating terminal.

It can be understood that embodiments of the present disclosure do not limit the manner in which the relay terminal obtains the address information of the initiating terminal, and the manner for obtaining the address information of the initiating terminal will be described below in connection with specific embodiments, which is not limited in the present disclosure.

In some implementations, the address information of the initiating terminal is obtained by the relay terminal from the initiating terminal.

For example, the address information of the initiating terminal is obtained from the first request message and/or the second request message from the initiating terminal. For the specific implementations of the first request message and the second request message, reference can be made to related descriptions of method 200 and is not repeated herein for brevity.

In some implementations, the address information of the initiating terminal is obtained by the relay terminal from the context of the first target connection, stored in the relay terminal, between the relay terminal and the initiating terminal.

For example, in the case where the first target connection has been established between the initiating terminal and the relay terminal, the context of the first target connection can be stored in the relay terminal, and the context of the first target connection can include the address information of the initiating terminal.

In yet another implementation, the address information of the initiating terminal is obtained by the relay terminal in a secure interaction procedure between the relay terminal and the initiating terminal.

For example, in the case where the first target connection has not been established between the initiating terminal and the relay terminal, the initiating terminal can initiate a procedure for establishing the first target connection in which the initiating terminal and the relay terminal can perform secure interaction, and the initiating terminal can transmit the address information of the initiating terminal to the relay terminal in the secure interaction procedure.

In some embodiments of the present disclosure, the method 300 further includes the following. The target terminal transmits a third response message to the relay terminal.

Correspondingly, the relay terminal receives the third response message from the target terminal, where the third response message is a response message to the third request message.

In some embodiments, the third response message indicates that the target terminal determines to use the second target connection for communication between the initiating terminal and the target terminal. Alternatively, the third response message indicates that the target terminal determines to reuse the second target connection to transmit the service to-be-transmitted between the initiating terminal and the target terminal.

That is, the target terminal can notify the relay terminal via the third response message, that the target terminal determines to reuse the second target connection.

In some embodiments, the target terminal can reuse existing messages to realize the function of the third response message. For example, the target terminal uses a link modification accept message to acknowledge to reuse the established connection. Alternatively, the relay terminal can introduce a new message to realize the function of the third response message, and the present disclosure does not limit the specific implementation of the third response message.

For example, the third response message is the link modification accept message, or a connection modification accept message or a connection reuse accept message can be introduced to reuse the established connection.

Optionally, the third response message can indicate that the target terminal accepts a modification to the established second target connection. For example, the target terminal accepts addition of a new initiating terminal served by the second target connection.

In some embodiments, the third response message contains the address information of the target terminal.

That is, the relay terminal can obtain the address information of the target terminal from the third response message.

In some embodiments, the address information of the target terminal can be used by the relay terminal to determine to which terminal device the service to-be-transmitted is to be routed or forwarded.

In some embodiments, the address information of the target terminal includes, but is not limited to, IP address information of the target terminal and/or MAC address information of the target terminal.

### Embodiment 4:

In other embodiments of the present disclosure, the operations at S310 include the following. In the case where the second target connection has not been established between the relay terminal and the target terminal, the relay terminal determines to establish the second target connection for communication between the initiating terminal and the target terminal.

Therefore, in embodiments of the present disclosure, in the case where the second target connection has not been established between the relay terminal and the target terminal, the relay terminal can initiate a procedure for establishing the second target connection for communication between the initiating terminal and the target terminal.

In some embodiments of the present disclosure, the method 300 further includes the following. The relay terminal transmits a fourth request message to the target terminal, where the fourth request message is used for requesting to establish the second target connection between the relay terminal and the target terminal.

Correspondingly, the target terminal receives the fourth request message from the relay terminal.

For example, in the case where the second target connection has not been established between the relay terminal and the target terminal, the relay terminal transmits the fourth request message to the target terminal.

For another example, in the case where the relay terminal determines to establish the second target connection, the relay terminal transmits the fourth request message to the target terminal.

In some embodiments, the relay terminal can reuse existing messages to realize the function of the fourth request message. For example, the relay terminal uses a direct communication request message to request to establish a connection (i.e., the fourth request message can be the direct communication request message). Alternatively, the relay terminal can introduce a new message to realize the function of the fourth request message, and the present disclosure does not limit the specific implementation of the fourth request message.

In some embodiments, the fourth request message contains at least one of: the ID information of the initiating terminal, ID information of the target terminal, the address information of the initiating terminal, or information of the service to-be-transmitted.

Optionally, the target terminal can determine, according to the ID information of the initiating terminal and the ID information of the target terminal carried in the fourth request message, the initiating terminal and the target terminal served by the connection to-be-established.

In some embodiments, the ID information of the initiating terminal is used for identifying the initiating terminal. For example, the ID information of the initiating terminal can include, but is not limited to, an application layer ID and/or a link layer ID, e.g. a layer 2-ID, of the initiating terminal.

In some embodiments, the ID information of the target terminal is used for identifying the target terminal. For example, the ID information of the target terminal includes, but is not limited to, an application layer ID and/or a link layer ID, e.g., a layer 2-ID, of the target terminal.

In some embodiments, the address information of the initiating terminal includes, but is not limited to, IP address information of the initiating terminal and/or MAC address information of the initiating terminal.

In some embodiments, the information of the service to-be-transmitted includes, but is not limited to, at least one of: an application ID, a type, or an RSC of the service to-be-transmitted.

It can be understood that embodiments of the present disclosure do not limit the manner in which the relay terminal obtains the ID information of the initiating terminal, and the manner for obtaining the ID information of the initiating terminal will be described below in connection with specific embodiments, which is not limited in the present disclosure.

In some implementations, the ID information of the initiating terminal is obtained by the relay terminal from the initiating terminal.

For example, the ID information of the initiating terminal is obtained from the first request message and/or the second request message from the initiating terminal. For the specific implementation of the first request message and the second request message, reference can be made to related descriptions of method 200 and is not repeated herein for brevity.

In other implementations, the ID information of the initiating terminal is obtained by the relay terminal from the context of the first target connection, stored in the relay terminal, between the relay terminal and the initiating terminal.

For example, in the case where the first target connection has been established between the initiating terminal and the relay terminal, the context of the first target connection can be stored in the relay terminal, and the context of the first target connection can include the ID information of the initiating terminal.

It can be understood that embodiments of the present disclosure do not limit the manner in which the relay terminal obtains the ID information of the target terminal, and the manner for obtaining the ID information of the target terminal will be described below in connection with specific embodiments, which is not limited in the present disclosure.

In some implementations, the ID information of the target terminal is obtained by the relay terminal from the initiating terminal.

For example, the ID information of the target terminal is obtained from the first request message and/or the second request message from the initiating terminal. For the specific implementation of the first request message and the second request message, reference can be made to related descriptions of method 200 and is not repeated herein for brevity.

It can be understood that embodiments of the present disclosure do not limit the manner in which the relay terminal obtains the address information of the initiating terminal, and the manner for obtaining the address information of the initiating terminal will be described below in connection with specific embodiments, which is not limited in the present disclosure.

In some implementations, the address information of the initiating terminal is obtained by the relay terminal from the initiating terminal.

For example, the address information of the initiating terminal is obtained from the first request message and/or the second request message from the initiating terminal. For the specific implementation of the first request message and the second request message, reference can be made to related descriptions of method 200 and is not repeated herein for brevity.

In some implementations, the address information of the initiating terminal is obtained by the relay terminal from the context of the first target connection, stored in the relay terminal, between the relay terminal and the initiating terminal.

For example, in the case where the first target connection has been established between the initiating terminal and the relay terminal, the context of the first target connection can be stored in the relay terminal, and the context of the first target connection can include the address information of the initiating terminal.

In yet another implementation, the address information of the initiating terminal is obtained by the relay terminal in a secure interaction procedure between the relay terminal and the initiating terminal.

For example, in the case where the first target connection has not been established between the initiating terminal and the relay terminal, the initiating terminal can initiate a procedure for establishing the first target connection in which the initiating terminal and the relay terminal can perform secure interaction, and the initiating terminal can transmit the address information of the initiating terminal to the relay terminal in the secure interaction procedure.

In some embodiments, the information of the service to-be-transmitted is obtained by the relay terminal from the initiating terminal.

For example, the information of the service to-be-transmitted is obtained from the second request message from the initiating terminal, where the second request message is used for requesting to establish the first target connection.

In some embodiments, the information of the service to-be-transmitted is obtained by the relay terminal from the context of the first target connection, stored in the relay terminal, between the relay terminal and the initiating terminal.

For example, in the case where the first target connection has been established between the relay terminal and the initiating terminal, the context of the first target connection can be stored in the relay terminal, and the context of the first target connection can include the information of the service to-be-transmitted.

In some embodiments of the present disclosure, the method 300 further includes the following. The relay terminal and the target terminal can perform the secure interaction procedure.

Optionally, the target terminal transmits the address information of the target terminal to the relay terminal in the secure interaction procedure between the relay terminal and the target terminal.

That is, the relay terminal can obtain the address information of the target terminal in the secure interaction procedure between the relay terminal and the target terminal.

In some embodiments of the present disclosure, the method 300 further includes the following. The target terminal transmits a fourth response message to the relay terminal.

Correspondingly, the relay terminal receives the fourth response message from the target terminal, where the fourth response message is a response message to the fourth request message.

In some embodiments, the fourth response message indicates that establishment of the second target connection is completed.

In some embodiments, the target terminal can reuse existing messages to realize the function of the fourth response message. For example, the target terminal uses a direct communication accept message to indicate that the establishment of the connection is completed (i.e., the fourth response message can be the direct communication accept message) Alternatively, the target terminal can introduce a new message to realize the function of the fourth response message, and the present disclosure does not limit the specific implementation of the fourth response message.

In some embodiments, the fourth response message contains the address information of the target terminal.

That is, the relay terminal can obtain the address information of the target terminal from the fourth response message.

In some embodiments, the address information of the target terminal is obtained by the relay terminal after the fourth response message is received by the relay terminal.

For example, after the relay terminal receives the fourth response message from the target terminal, the relay terminal and the target terminal can perform IP address negotiation, such that the relay terminal obtains the address information of the target terminal.

For another example, after the relay terminal receives the fourth response message from the target terminal, the relay terminal and the target terminal can perform an IP address allocation, such that the relay terminal obtains the address information of the target terminal.

In summary, the address information of the target terminal can be obtained by the relay terminal from the target terminal; can be obtained by the relay terminal from the context of the second target connection, stored in the relay terminal, between the relay terminal and the target terminal; can be obtained by the relay terminal in the secure interaction procedure between the relay terminal and the target terminal; can be negotiated by the relay terminal and the target terminal; or can be allocated by the relay terminal to the target terminal.

In some embodiments of the present disclosure, the method 300 further includes the following. The relay terminal receives the first request message from the initiating terminal, where the first request message is used for requesting to use the first target connection between the initiating terminal and the relay terminal for communication between the initiating terminal and the target terminal.

In some embodiments, the first request message contains the ID information of the target terminal and/or the address information of the initiating terminal.

In some embodiments, the first request message is a link modification request message.

In some embodiments of the present disclosure, the method 300 further includes the following. The relay terminal transmits a first response message to the initiating terminal, where the first response message indicates that the relay terminal determines to use the first target connection for communication between the initiating terminal and the target terminal.

In some embodiments, the first response message contains the address information of the target terminal.

In some embodiments, the address information of the target terminal is obtained by the relay terminal from the target terminal.

In some embodiments, the address information of the target terminal is negotiated by the relay terminal and the relay terminal.

In some embodiments, the address information of the target terminal is allocated by the relay terminal to the target terminal.

In some embodiments, the address information of the target terminal is obtained by the relay terminal from the target terminal as follows. The relay terminal obtains the address information of the target terminal from the third response message and/or the fourth response message from the target terminal, where the third response message indicates that the target terminal determines to use the second target connection for communication between the initiating terminal and the target terminal, and the fourth response message indicates that the establishment of the second target connection is completed; and/or the relay terminal obtains the address information of the target terminal in the secure interaction procedure between the relay terminal and the target terminal.

In some embodiments, the first response message is a link modification accept message.

In some embodiments of the present disclosure, the method 300 further includes the following. The relay terminal receives the second request message from the initiating terminal, where the second request message is used for requesting to establish the first target connection between the initiating terminal and the relay terminal for communication between the initiating terminal and the target terminal.

In some embodiments, the second request message contains at least one of: the ID information of the initiating terminal, the ID information of the target terminal, the address information of the initiating terminal, or the information of the service to-be-transmitted.

In some embodiments, the ID information of the target terminal is used by the relay terminal to determine whether a connection for the service to-be-transmitted has been established between the target terminal and the relay terminal.

In some embodiments, the information of the service to-be-transmitted is used by the relay terminal to determine whether the connection for the service to-be-transmitted has been established between the relay terminal and the target terminal.

In some embodiments, the second request message is the direct communication request message.

In some embodiments, the method 300 further includes the following. The relay terminal obtains the address information of the initiating terminal in the secure interaction procedure between the relay terminal and the initiating terminal.

In some embodiments, the method 300 further includes the following. The relay terminal transmits the second response message to the initiating terminal, where the second response message indicates that the establishment of the first target connection is completed.

In some embodiments, the second response message contains the address information of the target terminal.

For the manner for obtaining the address information of the target terminal, reference can be made to related descriptions of the foregoing embodiments and is not repeated herein.

In some embodiments, the second response message is the direct communication accept message.

For the specific implementations of the first request message, the first response message, the second request message, and the second response message, reference can be made to related descriptions in the method 200 and is not repeated herein for brevity.

In summary, in embodiments of the present disclosure, the relay terminal can execute a corresponding procedure for communication between the initiating terminal and the target terminal according to whether the connection for the service to-be-transmitted between the initiating terminal and the target terminal has been established between the relay terminal and the target terminal.

For example, when the connection for the service to-be-transmitted has been established between the relay terminal and the target terminal, the procedure for reusing the connection can be performed.

For another example, when the connection for the service to-be-transmitted has not been established between the relay terminal and the target terminal, the procedure for establishing the connection can be performed.

Therefore, in embodiments of the present disclosure, the PC5 connection between the relay terminal and the target terminal can serve multiple initiating terminals, and the relay terminal routes data according to the address information of the initiating terminals. For example, the relay terminal forwards IP data according to the IP address of the initiating terminals. In this way, data from different initiating terminals via the same connection can be distinguished according to different IP addresses, which is conducive to avoiding the establishment of the separate PC5 connection between the relay terminal and the target terminal for each initiating terminal. In other words, the connections between the initiating terminal and the relay terminal are not required to be in one-to-one mapping with the connections between the relay terminal and the target terminal, which is conducive to decreasing the number of connections for relay communication via the relay terminal and reducing the processing complexity of the relay terminal.

It can be noted that in embodiments of the present disclosure, Embodiment 3 and Embodiment 4 of the method 300 and Embodiment 1 and Embodiment 2 of the method 200 can be implemented in combination. For example, Embodiment 1 and Embodiment 3 can be implemented in combination, Embodiment 2 and Embodiment 3 can be implemented in combination, Embodiment 1 and Embodiment 4 can be implemented in combination, and Embodiment 2 and Embodiment 4 can be implemented in combination.

For example, in the case where the first target connection has been established between the initiating terminal and the relay terminal and the second target connection has been established between the relay terminal and the target terminal, the initiating terminal can reuse the first target connection, and the relay terminal can reuse the second target connection.

For another example, in the case where the first target connection has been established between the initiating terminal and the relay terminal and the second target connection has not been established between the relay terminal and the target terminal, the initiating terminal can reuse the first target connection, and the relay terminal can establish the second target connection.

For another example, in the case where the first target connection has not been established between the initiating terminal and the relay terminal and the second target connection has been established between the relay terminal and the target terminal, the initiating terminal can establish the first target connection, and the relay terminal can reuse the second target connection.

For yet another example, in the case where the first target connection has not been established between the initiating terminal and the relay terminal and the second target connection has not been established between the relay terminal and the target terminal, the initiating terminal can establish the first target connection, and the relay terminal can establish the second target connection.

The method for relay communication according to embodiments of the present disclosure is described in detail above in conjunction with FIG. 5 and FIG. 6 from the perspective of the initiating terminal and the relay terminal, respectively. The method for relay communication according to yet another embodiment of the present disclosure will be described in detail below in conjunction with FIG. 7 from the perspective of a target terminal. It can be understood that the descriptions of the target device side and the descriptions of the relay terminal side correspond to each other, and for similar descriptions, reference can be made to the above, which are not repeated herein for brevity.

FIG. 7 is a schematic flowchart of a method 400 for relay communication according to another embodiment of the present disclosure. As illustrated in FIG. 7, the method 400 includes the following.

S410, a target terminal receives a third request message or a fourth request message from a relay terminal, where the third request message is used for requesting to use a second target connection between the relay terminal and the target terminal for communication between an initiating terminal and the target terminal, and the fourth request message is used for requesting to establish the second target connection between the relay terminal and the target terminal for communication between the initiating terminal and the target terminal.

In some embodiments, a third request message is transmitted by the relay terminal in the case where the second target connection has been established.

In some embodiments, the third request message contains ID information of the initiating terminal or address information of the initiating terminal.

In some embodiments, the third request message is a link modification request message.

In some embodiments, the method 400 further includes the following. The target terminal transmits a third response message to the relay terminal, where the third response message indicates that the target terminal determines to use the second target connection for communication between the initiating terminal and the target terminal.

In some embodiments, the third response message contains address information of the target terminal.

In some embodiments, the third response message is a link modification accept message.

In some embodiments, the fourth request message is transmitted by the relay terminal in the case where the second target connection has not been established between the relay terminal and the target terminal.

In some embodiments, the fourth request message contains at least one of: the ID information of the initiating terminal, ID information of the target terminal, the address information of the initiating terminal, or information of the service to-be-transmitted.

In some embodiments, the ID information of the initiating terminal is obtained by the relay terminal from a first request message and/or a second request message from the initiating terminal, where the first request message is used for requesting to use a first target connection for communication between the initiating terminal and the target terminal, and the second request message is used for requesting to establish the first target connection. Alternatively, the ID information of the initiating terminal is obtained by the relay terminal from context of the first target connection, stored in the relay terminal, between the relay terminal and the initiating terminal.

In some embodiments, the ID information of the target terminal is obtained by the relay terminal from the first request message or the second request message from the initiating terminal, where the first request message is used for requesting to use the first target connection between the relay terminal and the initiating terminal for communication between the initiating terminal and the target terminal, and the second request message is used for requesting to establish the first target connection.

In some embodiments, the address information of the initiating terminal is obtained by the relay terminal from the first request message or the second request message from the initiating terminal, where the first request message is used for requesting to use the first target connection for communication between the initiating terminal and the target terminal, and the second request message is used for requesting to establish the first target connection. Alternatively, the address information of the initiating terminal is obtained by the relay terminal from the context of the first target connection, stored in the relay terminal, between the relay terminal and the initiating terminal. Alternatively, the address information of the initiating terminal is obtained by the relay terminal in a secure interaction procedure between the relay terminal and the initiating terminal.

In some embodiments, the information of the service to-be-transmitted is obtained by the relay terminal from the second request message from the initiating terminal, where the second request message is used for requesting to establish the first target connection. Alternatively, the information of the service to-be-transmitted is obtained by the relay terminal from the context of the first target connection, stored in the relay terminal, between the relay terminal and the initiating terminal.

In some embodiments, the fourth request message is a direct communication request message.

In some embodiments, the method 400 further includes the following. The target terminal transmits the address information of the target terminal to the relay terminal in a secure interaction procedure between the target terminal and the relay terminal.

In some embodiments, the method 400 further includes the following. The target terminal transmits a fourth response message to the relay terminal, where the fourth response message indicates that establishment of the second target connection is completed.

In some embodiments, the fourth response message contains the address information of the target terminal.

In some embodiments, the fourth response message is a direct communication accept message.

For the specific implementations of the third request message, the third response message, the fourth request message, and the fourth response message, reference can be made to related descriptions in method 300 and is not repeated herein for brevity.

The method for relay communication according to embodiments of the present disclosure is described in detail above in conjunction with FIG. 5 to FIG. 7 from the perspective of the initiating terminal, the relay terminal, and the target terminal, respectively. The method for relay communication according to embodiments of the present disclosure will be described in detail below in conjunction with FIG. 8 to FIG. 10 from the perspective of interactions between devices.

FIG. 8 is a schematic diagram illustrating interaction in a method for relay communication according to an embodiment of the present disclosure.

In this embodiment, a PC5 connection has not been established between an initiating UE and a relay UE, or a PC5 connection for a service to-be-transmitted between the initiating UE and a target UE has not been established between the initiating UE and the relay UE; and a PC5 connection has been established between the relay UE and the target UE, or the PC5 connection for the service to-be-transmitted between the initiating UE and the target UE has been established between the relay UE and the target UE. In other words, a first target connection has not been established between the initiating UE and the relay UE, and a second target connection has been established between the relay UE and the target UE.

As illustrated in FIG. 8, a method 500 can include the following.

S501, the initiating UE transmits a second request message to the relay UE, where the second request message is used for requesting to establish the PC5 connection between the initiating UE and the relay UE or the PC5 connection for the service to-be-transmitted between the initiating UE and the relay UE.

For example, in the case where the PC5 connection or the PC5 connection for the service to-be-transmitted has not been established between the initiating UE and the relay UE, the initiating UE transmits the second request message to the relay UE.

In some embodiments, the second request message contains ID information of the initiating UE and ID information of the target UE.

Optionally, the ID information of the initiating UE can include an application layer ID and/or a link layer ID, e.g., a layer 2-ID, of the initiating UE.

Optionally, the ID information of the target UE initiating UE can include an application layer ID and/or a link layer ID, e.g., a layer 2-ID, of the target UE.

Optionally, the second request information can further include information of the service to-be-transmitted, such as an application ID, a type, an RSC, etc., of the service to-be-transmitted.

Optionally, the second request message can further include address information of the initiating UE, such as an IP address, an MAC address, etc., of the initiating UE.

S502, the relay UE and the initiating UE perform secure interaction.

Optionally, the initiating UE can transmit the address information of the initiating UE to the relay UE in the secure interaction procedure.

S503, the relay UE transmits a third request message to the target UE, where the third request message is used for requesting to use the second target connection to transmit the service to-be-transmitted between the initiating UE and the target UE.

For example, in the case where the PC5 connection or the PC5 connection for the service to-be-transmitted has been established between the relay UE and the target UE, the relay UE transmits the third request message to the target UE.

In some embodiments, the third request message can be a link modification request message for the established PC5 connection.

In some embodiments, the third request message can include the ID information of the initiating UE.

Optionally, the third request message can further include the address information of the initiating UE, such as the IP address, the MAC address, etc., of the initiating UE.

S504, the target UE transmits a third response message to the relay UE, where the third response message indicates that the target UE determines to reuse the second target connection.

In some embodiments, the third response message can be a link modification accept message for the established PC5 connection.

In some embodiments, the third response message can include address information of the target UE, such as an IP address, a MAC address, etc., of the target UE.

S505, the relay UE transmits a second response message to the initiating UE, where the second response message indicates that establishment of the PC5 connection between the relay UE and the initiating UE is completed.

In some embodiments, the second response message contains the address information of the target UE.

In some embodiments, the address information of the target UE can be obtained by the relay UE from the third response message.

In other embodiments, the second target connection has been established between the relay UE and the target UE, context of the second target connection is stored in the relay UE, and the address information of the target UE can also be obtained by the relay UE from the context of the second target connection stored in the relay UE.

Based on this embodiment, the PC5 connection between the relay UE and the target UE can serve multiple initiating UEs, and the relay UE routes data according to the address information of the initiating UEs. For example, when data from different initiating UEs is transmitted via a same connection, the data can be distinguished according to different IP addresses, which is conducive to avoiding establishment of a separate PC5 connection between the relay UE and the target UE for each initiating UE. In other words, the connections between the initiating UE and the relay UE are not required to be in one-to-one mapping with the connections between the relay UE and the target UE, which is conducive to decreasing the number of connections for relay communication via the relay terminal and reducing the processing complexity of the relay terminal.

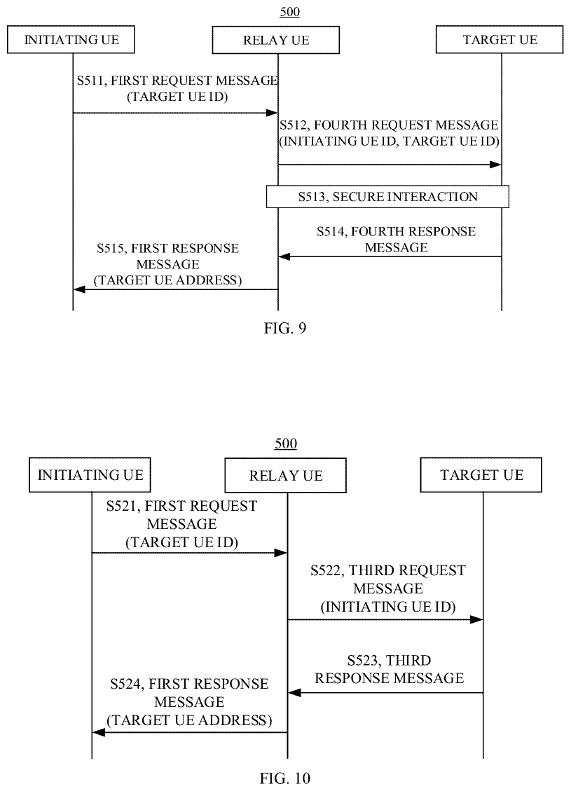

FIG. 9 is a schematic diagram illustrating interaction in a method for relay communication according to another embodiment of the present disclosure.

In this embodiment, a PC5 connection has been established between an initiating UE and a relay UE, or a PC5 connection for a service to-be-transmitted between the initiating UE and a target UE has been established between the initiating UE and the relay UE; and a PC5 connection has not been established between the relay UE and the target UE, or a PC5 connection for the service to-be-transmitted between the initiating UE and the target UE has not been established between the relay UE and the target UE. In other words, a first target connection has been established between the initiating UE and the relay UE, and a second target connection has not been established between the relay UE and the target UE.

As illustrated in FIG. 9, a method 500 can include the following.

S511, the initiating UE transmits a first request message to the relay UE, where the first request message is used for requesting to use the established PC5 connection between the initiating UE and the relay UE.

For example, in the case where the PC5 connection or the PC5 connection for the service to-be-transmitted has been established between the initiating UE and the relay UE, the initiating UE transmits the first request message to the relay UE.

In some embodiments, the first request message contains ID information of the target UE.

Optionally, the ID information of the target UE can include an application layer ID and/or a link layer ID, e.g., a layer 2-ID, of the target UE.

Optionally, the first request message can further include address information of the initiating UE, such as an IP address, an MAC address, etc., of the initiating UE.

S512, the relay UE transmits a fourth request message to the target UE, where the fourth request message is used for requesting to establish the second target connection to transmit the service to-be-transmitted between the initiating UE and the target UE.

For example, in the case where the PC5 connection or the PC5 connection for the service to-be-transmitted has not been established between the relay UE and the target UE, the relay UE transmits the fourth request message to the target UE.

In some embodiments, the fourth request message can be a direct communication request message.

In some embodiments, the fourth request message can include ID information of the initiating UE and the ID information of the target UE.

Optionally, the fourth request message further includes information of the service to-be-transmitted, such as an application ID, a type, an RSC, etc., of the service to-be-transmitted.

Optionally, the fourth request message further includes address information of the initiating UE, such as an IP address, an MAC address, etc., of the initiating UE.

Optionally, the ID information of the initiating UE can be obtained by the relay UE from context of the first target connection stored in the relay UE or can be obtained by the relay UE from the initiating UE.

Optionally, the address information of the target UE can be obtained by the relay UE

from the context of the first target connection stored in the relay UE or can be obtained by the relay UE from the initiating UE.

Optionally, the information of the service to-be-transmitted can be obtained by the relay UE from the context of the first target connection stored in the relay UE or can be obtained by the relay UE from the initiating UE.

S513, the relay UE and the target UE perform secure interaction.

Optionally, the target UE can transmit the address information of the target UE to the relay UE in the secure interaction procedure.

S514, the target UE transmits a fourth response message to the relay UE, where the fourth response message indicates that the target UE determines to establish the second target connection.

In some embodiments, the fourth response message can be a direct communication accept message.

In some embodiments, the fourth response message can include the address information of the target UE, such as an IP address, a MAC address, etc., of the target UE.

In other embodiments, after the fourth response message is received by the relay UE, the relay UE and the target UE perform IP address negotiation or allocation, such that the relay

UE obtains the address information of the target UE.

S515, the relay UE transmits a first response message to the initiating UE, where the first response message indicates that the relay terminal determines to reuse the PC5 connection between the relay UE and the initiating UE.

In some embodiments, the first response message can be a link modification accept message for the established PC5 connection.

In some embodiments, the first response message contains the address information of the target UE.

In some embodiments, the address information of the target UE can be obtained by the relay UE from the fourth response message or can be obtained after the fourth response message is received by the relay UE.

Based on this embodiment, the PC5 link between the relay UE and the initiating UE can serve multiple target UEs, and the relay UEs route data according to the address information of the target UEs. For example, when data is transmitted to different target UEs via a same connection, the data can be differentiated according to different IP addresses, which is conducive to avoiding establishment of a separate PC5 link between the relay UE and the initiating UE for each target UE. In other words, the links between the initiating UE and the relay UE are not required to be in one-to-one mapping with the links between the relay UE and the target UE, which is conducive to decreasing the number of links for relay communication via the relay terminal and reducing the processing complexity of the relay terminal.

FIG. 10 is a schematic diagram illustrating interaction in a method for relay communication according to yet another embodiment of the present disclosure.

In this embodiment, a PC5 connection has been established between an initiating UE and a relay UE, or a PC5 connection for a service to-be-transmitted between the initiating UE and a target UE has been established between the initiating UE and the relay UE; and a PC5 connection has been established between the relay UE and the target UE, or a PC5 connection for the service to-be-transmitted between the initiating UE and the target UE has been established between the relay UE and the target UE. In other words, a first target connection has been established between the initiating UE and the relay UE, and a second target connection has been established between the relay UE and the target UE. As illustrated in FIG. 10, a method 500 can include the following.

S521, the initiating UE transmits a first request message to the relay UE, where the first request message is used for requesting to use the established PC5 connection between the initiating UE and the relay UE.

For example, in the case where the PC5 connection or the PC5 connection for the service to-be-transmitted has been established between the initiating UE and the relay UE, the initiating UE transmits the first request message to the relay UE.

In some embodiments, the first request message contains ID information of the target UE.

Optionally, the ID information of the target UE can include an application layer ID and/or a link layer ID, e.g., a layer 2-ID, of the target UE.

Optionally, the first request message can further include address information of the initiating UE, such as an IP address, an MAC address, etc., of the initiating UE.

S522, the relay UE transmits a third request message to the target UE, where the third request message is used for requesting to use the second target connection to transmit the service to-be-transmitted between the initiating UE and the target UE.

For example, in the case where the PC5 connection or the PC5 connection for the service to-be-transmitted has been established between the relay UE and the target UE, the relay UE transmits the third request message to the target UE.

In some embodiments, the third request message can be a link modification request message for the established PC5 connection.

In some embodiments, the third request message can include ID information of the initiating UE.

Optionally, the third request message can further include address information of the initiating UE, such as an IP address, a MAC address, etc., of the initiating UE.

Optionally, the ID information of the initiating UE can be obtained by the relay UE from context of the second target connection stored in the relay UE or can be obtained by the relay UE from the initiating UE.

Optionally, the address information of the initiating UE can be obtained by the relay UE from the context of the second target connection stored in the relay UE or can be obtained by the relay UE from the initiating UE.

S523, the target UE transmits a third response message to the relay UE, where the third response message indicates that the target UE determines to reuse the second target connection.

In some embodiments, the third response message can be a link modification accept message for the established PC5 connection.

In some embodiments, the third response message can include address information of the target UE, such as an IP address, an MAC address, etc., of the target UE.

S524, the relay UE transmits a first response message to the initiating UE, where the first response message indicates that the relay UE determines to reuse the PC5 connection between the relay UE and the initiating UE.

In some embodiments, the first response message can be a link modification accept message for an established PC5 connection.

In some embodiments, the first response message contains address information of the target UE.

In some embodiments, the address information of the target UE can be obtained by the relay UE from the third response message or from the context of the second target connection stored in the relay UE.

Based on this embodiment, the PC5 connection between the relay UE and the initiating UE can serve multiple target UEs, the PC5 connection between the relay UE and the target UE can serve multiple initiating UEs, and the relay UEs route data according to the address information. For example, when data is transmitted to different target UEs via a same connection, the data can be differentiated according to different IP addresses; and when data from different initiating UEs is transmitted via a same connection, the data can be differentiated according to different IP addresses, which is conducive to avoiding establishment of a separate PC5 connection between the relay UE and the initiating UE for each target UE and establishment of a separate PC5 connection between the relay UE and the target UE for each initiating UE. In other words, the connections between the initiating UE and the relay UE are not required to be in one-to-one mapping with the connections between the relay UE and the target UE, which is conducive to decreasing the number of connections for relay communication via the relay terminal and reducing the processing complexity of the relay terminal.

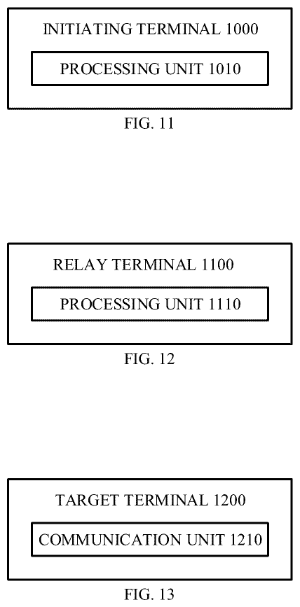

The method embodiments of the present disclosure are described in detail above with reference to FIG. 5 to FIG. 10, and apparatus embodiments of the disclosure will be described in detail below with reference to FIG. 11 to FIG. 16. It can be understood that, the apparatus embodiments and the method embodiments correspond to each other, and for similar content, reference can be made to the method embodiments.

FIG. 11 illustrates a schematic block diagram of an initiating terminal 1000 according to embodiments of the present disclosure. As illustrated in FIG. 11, the initiating terminal 1000 includes a processing unit 1010. The processing unit 1010 is configured to determine, according to whether a first target connection has been established between the initiating terminal and a relay terminal, whether to use the first target connection for communication between the initiating terminal and a target terminal.

In some embodiments, the processing unit 1010 is further configured to determine to use the first target connection for communication between the initiating terminal and the target terminal in the case where the first target connection has been established between the initiating terminal and the relay terminal, the initiating terminal. Alternatively, the processing unit 1010 is further configured to establish the first target connection for communication between the initiating terminal and the target terminal in the case where the first target connection has not been established between the initiating terminal and the relay terminal.

In some embodiments, the initiating terminal 1000 further includes a communication unit. The communication unit is configured to transmit a first request message to the relay terminal in the case where the initiating terminal determines to use the first target connection for communication between the initiating terminal and the target terminal, where the first request message is used for requesting to use the first target connection for communication between the initiating terminal and the target terminal.

In some embodiments, the first request message contains ID information of the target terminal and/or address information of the initiating terminal.

In some embodiments, the first request message is a link modification request message.

In some embodiments, the initiating terminal 1000 further includes the communication unit. The communication unit is configured to receive a first response message from the relay terminal, where the first response message indicates that the relay terminal determines to use the first target connection for communication between the initiating terminal and the target terminal.

In some embodiments, the first response message contains address information of the target terminal.

In some embodiments, the first response message is a link modification accept message.

In some embodiments, the initiating terminal 1000 further includes the communication unit. The communication unit is configured to transmit a second request message to the relay terminal in the case where the initiating terminal determines to establish the first target connection, where the second request message is used for requesting to establish the first target connection.

In some embodiments, the second request message is a direct communication request message.

In some embodiments, the second request message contains at least one of: ID information of the initiating terminal, ID information of the target terminal, address information of the initiating terminal, or information of a service to-be-transmitted

In some embodiments, the initiating terminal 1000 further includes the communication unit. The communication unit is configured to transmit the address information of the initiating terminal to the relay terminal in a secure interaction procedure between the relay terminal of the initiating terminal.

In some embodiments, the initiating terminal 1000 further includes the communication unit. The communication unit is configured to receive a second response message from the relay terminal, where the second response message indicates that establishment of the first target connection is completed.

In some embodiments, the second response message contains the address information of the target terminal.

In some embodiments, the second response message is a direct communication accept message.

In some embodiments, the address information of the initiating terminal includes IP address information of the initiating terminal and/or MAC address information of the initiating

In some embodiments, the address information of the target terminal includes IP address information of the target terminal and/or MAC address information of the target

In some embodiments, the information of the service to-be-transmitted includes at least one of: an application ID, a type, or an RSC of the service to-be-transmitted.

In some embodiments, the information of the service to-be-transmitted is used by the relay terminal to determine whether a connection for the service to-be-transmitted has been established between the relay terminal and the target terminal.

In some embodiments, the ID information of the target terminal includes an application layer ID and/or a link layer ID of the target terminal.

In some embodiments, the ID information of the initiating terminal includes an application layer ID and/or a link layer ID of the initiating terminal.

In some embodiments, the first target connection is a direct communication connection between the initiating terminal and the relay terminal. Alternatively, the first target connection is a direct communication connection for a specific service between the initiating terminal and the relay terminal, where the specific service is a service to be transmitted between the initiating terminal and the target terminal.

Optionally, in some embodiments, the communication unit can be a communication interface, a transceiver, or an input/output interface of a communication chip or a system-on-chip (SOC). The processing unit can be one or more processors.

It can be understood that the initiating terminal 1000 according to embodiments of the present disclosure can correspond to the initiating terminal in the method embodiments of the present disclosure. In addition, the above and other operations and/or functions of various units of the initiating terminal 1000 are respectively intended for implementing corresponding operations of the initiating terminal in the method embodiments illustrated in FIG. 5 to FIG. 10.

FIG. 12 illustrates a schematic block diagram of a relay terminal 1100 according to embodiments of the present disclosure. As illustrated in FIG. 12, the relay terminal 1100 includes a processing unit 1110. The processing unit 1110 is configured to determine, according to whether a second target connection has been established between the relay terminal and a target terminal, whether to use the second target connection for communication between an initiating terminal and the target terminal.

In some embodiments, the processing unit 1110 is further configured to determine to use the second target connection for communication between the initiating terminal and the target terminal in the case where the second target connection has been established between the relay terminal and the target terminal. Alternatively, the processing unit 1110 is further configured to determine to establish the second target connection for communication between the initiating terminal and the target terminal in the case where the second target connection has not been established between the relay terminal and the target terminal.

In some embodiments, the relay terminal 1100 further includes a communication unit. The communication unit is configured to transmit a third request message to the target terminal in the case where the relay terminal determines to use the second target connection for communication between the initiating terminal and the target terminal, where the third request message is used for requesting to use the second target connection for communication between the initiating terminal and the target terminal.

In some embodiments, the third request message contains ID information of the initiating terminal or address information of the initiating terminal.

In some embodiments, the third request message is a link modification request message.

In some embodiments, the relay terminal 1100 further includes the communication unit. The communication unit is configured to receive a third response message from the target terminal, where the third response message indicates that the target terminal determines to use the second target connection for communication between the initiating terminal and the target terminal.

In some embodiments, the third response message contains address information of the target terminal.

In some embodiments, the third response message is a link modification accept message.

In some embodiments, the relay terminal 1100 further includes the communication unit. The communication unit is configured to transmit a fourth request message to the target terminal in the case where the relay terminal determines to establish the second target connection between the relay terminal and the target terminal, where the fourth request message is used for requesting to establish the second target connection between the relay terminal and the target terminal

In some embodiments, the fourth request message contains at least one of: the ID information of the initiating terminal, ID information of the target terminal, the address information of the initiating terminal, or information of a service to-be-transmitted.

In some embodiments, the fourth request message is a direct communication request message.

In some embodiments, the relay terminal 1100 further includes the communication unit. The communication unit is configured to obtain, by the relay terminal, the address information of the target terminal in a secure interaction procedure between the relay terminal and the target terminal.

In some embodiments, the relay terminal 1100 further includes the communication unit. The communication unit is configured to receive a fourth response message from the target terminal, where the fourth response message indicates that establishment of the second target connection is completed.

In some embodiments, the fourth response message contains the address information of the target terminal.

In some embodiments, the fourth response message is a direct communication accept message.

In some embodiments, the processing unit 1110 is further configured to negotiate with the target terminal the address information of the target terminal after the fourth response message is received by the relay terminal.

In some embodiments, the processing unit 1110 is further configured to allocate the address information of the target terminal to the target terminal.

In some embodiments, the relay terminal 1100 further includes the communication unit. The communication unit is configured to receive a first request message from the initiating terminal, where the first request message is used for requesting to use a first target connection between the initiating terminal and the relay terminal for communication between the initiating terminal and the target terminal.

In some embodiments, the first request message contains the ID information of the target terminal and/or the address information of the initiating terminal.

In some embodiments, the first request message is a link modification request message.

In some embodiments, the relay terminal 1100 further includes the communication unit. The communication unit is configured to transmit a first response message to the initiating terminal, where the first response message indicates that the relay terminal determines to use the first target connection for communication between the initiating terminal and the target terminal.

In some embodiments, the first response message contains the address information of the target terminal.

In some embodiments, the first response message is a link modification accept message.

In some embodiments, the relay terminal 1100 further includes the communication unit. The communication unit is configured to receive a second request message from the initiating terminal, where the second request message is used for requesting to establish the first target connection between the initiating terminal and the relay terminal for communication between the initiating terminal and the target terminal.

In some embodiments, the second request message contains at least one of: the ID information of the initiating terminal, the ID information of the target terminal, the address information of the initiating terminal, or the information of the service to-be-transmitted.

In some embodiments, the information of the service to-be-transmitted is used by the relay terminal to determine whether a connection for the service to-be-transmitted has been established between the relay terminal and the target terminal.

In some embodiments, the second request message is the direct communication request message.

In some embodiments, the relay terminal 1100 further includes the communication unit. The communication unit is configured to obtain, by the relay terminal, the address information of the initiating terminal in a secure interaction procedure between the initiating terminal and the relay terminal.

In some embodiments, the relay terminal 1100 further includes the communication unit. The communication unit is configured to transmit a second response message to the initiating terminal, where the second response message indicates that establishment of the first target connection is completed.

In some embodiments, the second response message contains the address information of the target terminal.

In some embodiments, the second response message is the direct communication accept message.

In some embodiments, the ID information of the initiating terminal is obtained by the relay terminal from the first request message and/or the second request message from the initiating terminal, where the first request message is used for requesting to use the first target connection for communication between the initiating terminal and the target terminal, and the second request message is used for requesting to establish the first target connection. Alternatively, the ID information of the initiating terminal is obtained by the relay terminal from context of the first target connection, stored in the relay terminal, between the relay terminal and the initiating terminal.

In some embodiments, the ID information of the target terminal is obtained by the relay terminal from the first request message and/or the second request message from the initiating terminal, where the first request message is used for requesting to use the first target connection between the relay terminal and the initiating terminal for communication between the initiating terminal and the target terminal, and the second request message is used for requesting to establish the first target connection.

In some embodiments, the address information of the initiating terminal is obtained by the relay terminal from the first request message and/or the second request message from the initiating terminal, where the first request message is used for requesting to use the first target connection for communication between the initiating terminal and the target terminal, and the second request message is used for requesting to establish the first target connection. Alternatively, the address information of the initiating terminal is obtained by the relay terminal from the context of the first target connection, stored in the relay terminal, between the relay terminal and the initiating terminal. Alternatively, the address information of the initiating terminal is obtained by the relay terminal in the secure interaction procedure between the relay terminal and the initiating terminal.

In some embodiments, the information of the service to-be-transmitted is obtained by the relay terminal from the second request message from the initiating terminal, where the second request message is used for requesting to establish the first target connection. Alternatively, the information of the service to-be-transmitted is obtained by the relay terminal from the context of the first target connection, stored in the relay terminal, between the relay terminal and the initiating terminal.

In some embodiments, the address information of the target terminal is obtained by the relay terminal from the target terminal.

In some embodiments, the address information of the target terminal is negotiated by the relay terminal and the relay terminal.

In some embodiments, the address information of the target terminal is allocated by the relay terminal to the target terminal.

In some embodiments, the address information of the target terminal is obtained by the relay terminal from the target terminal as follows. The relay terminal obtains the address information of the target terminal from the third response message and/or the fourth response message from the target terminal, where the third response message indicates that the target terminal determines to use the second target connection for communication between the initiating terminal and the target terminal, and the fourth response message indicates that the establishment of the second target connection is completed; and/or the relay terminal obtains the address information of the target terminal in the secure interaction procedure between the relay terminal and the target terminal.

In some embodiments, the ID information of the initiating terminal includes an application layer ID and/or a link layer ID of the initiating terminal.

In some embodiments, the ID information of the target terminal includes an application layer ID and/or a link layer ID of the target terminal.

In some embodiments, the address information of the initiating terminal includes IP address information of the initiating terminal and/or MAC address information of the initiating terminal.

In some embodiments, the address information of the target terminal includes IP address information of the target terminal and/or MAC address information of the target terminal.

In some embodiments, the information of the service to-be-transmitted includes at least one of: an application ID, a type, or an RSC of the service to-be-transmitted.

In some embodiments, the second target connection is a direct communication connection between the relay terminal and the target terminal. Alternatively, the second target connection is a direct communication connection for a specific service between the relay terminal and the target terminal, where the specific service is a service to be transmitted between the initiating terminal and the target terminal.

Optionally, in some embodiments, the communication unit can be a communication interface, a transceiver, or an input/output interface of a communication chip or an SOC. The processing unit can be one or more processors.

It can be understood that the relay terminal 1100 according to embodiments of the present disclosure can correspond to the relay terminal in the method embodiments of the present disclosure. In addition, the above and other operations and/or functions of various units of the relay terminal 1100 are respectively intended for implementing corresponding operations of the relay terminal in the method embodiments illustrated in FIG. 5 to FIG. 10, which is not repeated herein for brevity.

FIG. 13 illustrates a schematic block diagram of a target terminal 1200 according to embodiments of the present disclosure. As illustrated in FIG. 13, the target terminal 1200 includes a communication unit 1210. The communication unit 1210 is configured to receive a third request message or a fourth request message from a relay terminal, where the third request message is used for requesting to use a second target connection between the relay terminal and the target terminal for communication between an initiating terminal and the target terminal, and the fourth request message is used for requesting to establish the second target connection between the relay terminal and the target terminal for communication between the initiating terminal and the target terminal.

In some embodiments, the third request message is transmitted by the relay terminal in the case where the second target connection has been established.

In some embodiments, the third request message contains ID information of the initiating terminal or address information of the initiating terminal.

In some embodiments, the third request message is a link modification request message.

In some embodiments, the communication unit 1210 is further configured to transmit a third response message to the relay terminal, where the third response message indicates that the target terminal determines to use the second target connection for communication between the initiating terminal and the target terminal.

In some embodiments, the third response message contains address information of the target terminal.

In some embodiments, the third response message is a link modification accept message.

In some embodiments, the fourth request message is transmitted by the relay terminal in the case where the second target connection has not been established between the relay terminal and the target terminal.

In some embodiments, the fourth request message contains at least one of: the ID information of the initiating terminal, the ID information of the target terminal, the address information of the initiating terminal, or information of a service to-be-transmitted.

In some embodiments, the fourth request message is a direct communication request message.

In some embodiments, the communication unit 1210 is further configured to transmit the address information of the target terminal to the relay terminal in a secure interaction procedure.

In some embodiments, the communication unit 1210 is further configured to transmit a fourth response message to the relay terminal, where the fourth response message indicates that establishment of the second target connection is completed.

In some embodiments, the fourth response message contains the address information of the target terminal.

In some embodiments, the fourth response message is a direct communication accept message.

In some embodiments, the ID information of the initiating terminal includes an application layer ID and/or a link layer ID of the initiating terminal.

In some embodiments, the ID information of the target terminal includes an application layer ID and/or a link layer ID of the target terminal.

In some embodiments, the address information of the initiating terminal includes IP address information of the initiating terminal and/or MAC address information of the initiating terminal.

In some embodiments, the address information of the target terminal includes IP address information of the target terminal and/or MAC address information of the target

In some embodiments, the information of the service to-be-transmitted includes at least one of: an application ID, a type, or an RSC of the service to-be-transmitted.

In some embodiments, the second target connection is a direct communication connection between the relay terminal and the target terminal. Alternatively, the second target connection is a direct communication connection for a specific service between the relay terminal and the target terminal, where the specific service is a service to be transmitted between the initiating terminal and the target terminal.

Optionally, in some embodiments, the communication unit can be a communication interface, a transceiver, or an input/output interface of a communication chip or an SOC. The processing unit can be one or more processors.

It can be understood that the target terminal 1200 according to embodiments of the present disclosure can correspond to the target terminal in the method embodiments of the present disclosure. In addition, the above and other operations and/or functions of various units of the target terminal 1200 are respectively intended for implementing corresponding operations of the target terminal in the method embodiments illustrated in FIG. 5 to FIG. 10, which is not repeated herein for brevity.

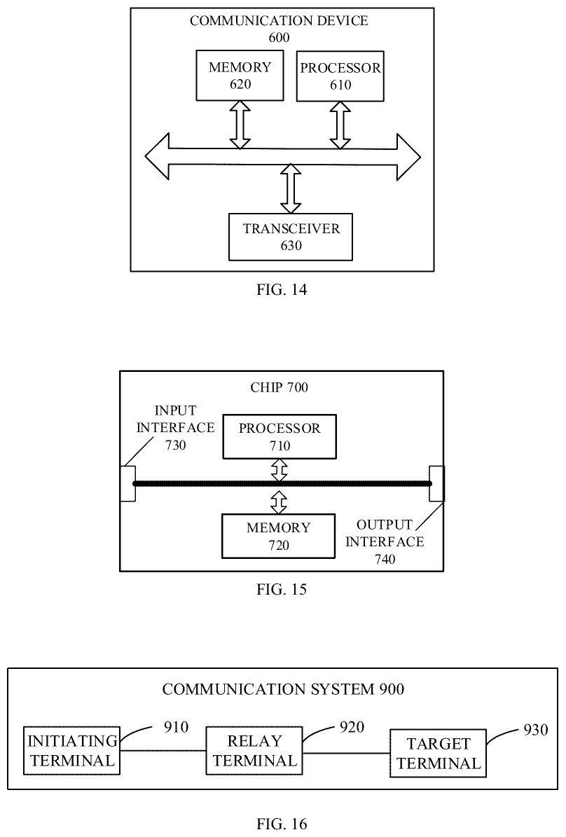

FIG. 14 is a schematic structural diagram of a communication device 600 provided in embodiments of the present disclosure. The communication device 600 illustrated in FIG. 14 includes a processor 610. The processor 610 can invoke and execute a computer program stored in a memory, to implement the method in embodiments of the present disclosure.

Optionally, as illustrated in FIG. 14, the communication device 600 can further include a memory 620, where the processor 610 can invoke and execute a computer program stored in the memory 620 to implement the method in embodiments of the present disclosure.

The memory 620 can be a separate device independent of the processor 610, or can be integrated into the processor 610.

Optionally, as illustrated in FIG. 14, the communication device 600 can further include a transceiver 630. The processor 610 can control the transceiver 630 to communicate with other devices, and specifically, to send information or data to other devices or receive information or data sent by other devices.

The transceiver 630 can include a transmitter and a receiver. The transceiver 630 can further include an antenna, where one or more antennas can be provided.

Optionally, the communication device 600 can specifically be the initiating terminal in embodiments of the present disclosure, and the communication device 600 can implement corresponding operations implemented by the initiating terminal in various methods in embodiments of the present disclosure, which is not repeated herein for brevity.

Optionally, the communication device 600 can specifically be the relay terminal in embodiments of the present disclosure, and the communication device 600 can implement corresponding operations implemented by the relay terminal in various methods in embodiments of the present disclosure, which is not repeated herein for brevity.

Optionally, the communication device 600 can specifically be the target terminal in embodiments of the present disclosure, and the communication device 600 can implement corresponding operations implemented by the target terminal in various methods in embodiments of the present disclosure, which is not repeated herein for brevity.

FIG. 15 is a schematic structural diagram of a chip according to embodiments of the present disclosure. The chip 700 illustrated in FIG. 15 includes a processor 710. The processor 710 can invoke and execute a computer program stored in a memory, so as to implement the method in embodiments of the present disclosure.

Optionally, as illustrated in FIG. 15, the chip 700 can further include a memory 720. The processor 710 can invoke and execute a computer program stored in the memory 720, so as to implement the method in embodiments of the present disclosure.

The memory 720 can be a separate device independent of the processor 710, or can be integrated into the processor 710.

Optionally, the chip 700 can further include an input interface 730. The processor 710 can control the input interface 730 to communicate with other devices or chips, and specifically, to obtain information or data sent by other devices or chips.

Optionally, the chip 700 can further include an output interface 740. The processor 710 can control the output interface 740 to communicate with other devices or chips, and specifically, to output information or data to other devices or chips.

Optionally, the chip is applicable to the initiating terminal in embodiments of the present disclosure, and the chip can implement corresponding operations implemented by the initiating device in various methods in embodiments of the present disclosure, which is not repeated herein for brevity.

Optionally, the chip is applicable to the relay terminal in embodiments of the present disclosure, and the chip can implement corresponding operations implemented by the relay device in various methods in embodiments of the present disclosure, which is not repeated herein for brevity.

Optionally, the chip is applicable to the target terminal in embodiments of the present disclosure, and the chip can implement corresponding operations implemented by the target device in various methods in embodiments of the present disclosure, which is not repeated herein for brevity.

It can be understood that the chip in embodiments of the present disclosure can also be an SOC.

FIG. 16 is a schematic block diagram of a communication system 900 provided in embodiments of the present disclosure. As illustrated in FIG. 16, the communication system 900 includes an initiating terminal 910, a relay terminal 920, and a target terminal 930.

The initiating terminal 910 can be configured to implement corresponding functions implemented by the initiating terminal in the foregoing method, the relay terminal 920 can be configured to implement corresponding functions implemented by the relay terminal in the foregoing method, and the target terminal 930 can be configured to implement corresponding functions implemented by the target terminal in the foregoing method, which is not repeated herein for brevity.

It can be understood that, the processor in embodiments of the present disclosure can be an integrated circuit chip with signal processing capabilities. During implementation, each step of the foregoing method embodiments can be completed by an integrated logic circuit of hardware in the processor or an instruction in the form of software. The processor can be a general-purpose processor, a digital signal processor (DSP), an application-specific integrated circuit (ASIC), a field programmable gate array (FPGA), or other programmable logic devices, discrete gates or transistor logic devices, discrete hardware components. The methods, steps, and logic blocks disclosed in embodiments of the present disclosure can be implemented or executed. The general-purpose processor can be a microprocessor, or the processor can be any conventional processor or the like. The steps of the method disclosed in embodiments of the present disclosure can be directly implemented by a hardware decoding processor, or can be performed by hardware and software modules in the decoding processor. The software module can be located in a storage medium such as a random access memory (RAM), a flash memory, a read-only memory (ROM), a programmable ROM (PROM), or an electrically erasable programmable memory, registers, and the like. The storage medium is located in the memory. The processor reads the information in the memory, and completes the steps of the method described above with the hardware thereof.

It can be understood that, the memory in embodiments of the present disclosure can be a volatile memory or a non-volatile memory, or can include both the volatile memory and the non-volatile memory. The non-volatile memory can be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that, the memory of the systems and methods described in the present disclosure is intended to include, but is not limited to, these and any other suitable types of memory.

It should be understood that, the memory above is intended for illustration rather than limitation. For example, the memory in embodiments of the present disclosure can also be an SRAM, a DRAM, an SDRAM, a DDR SDRAM, an ESDRAM, an SLDRAM, a DR RAM, etc. In other words, the memory in embodiments of the present disclosure is intended to include, but is not limited to, these and any other suitable types of memory.

Embodiments of the present disclosure further provide a computer-readable storage medium. The computer-readable storage medium is configured to store a computer program.

Optionally, the computer-readable storage medium is applicable to the initiating terminal in embodiments of the present disclosure, and the computer program is operable with a computer to execute corresponding operations implemented by the initiating terminal in various methods in embodiments of the present disclosure, which is not repeated herein for brevity.

Optionally, the computer-readable storage medium is applicable to the relay terminal in embodiments of the present disclosure, and the computer program is operable with a computer to execute corresponding operations implemented by the relay terminal in various methods in embodiments of the present disclosure, which is not repeated herein for brevity.

Optionally, the computer-readable storage medium is applicable to the target terminal in embodiments of the present disclosure, and the computer program is operable with a computer to execute corresponding operations implemented by the target terminal in various methods in embodiments of the present disclosure, which is not repeated herein for brevity.

Embodiments of the present disclosure further provide a computer program product. The computer program product includes computer program instructions.

Optionally, the computer program product is applicable to the initiating terminal in embodiments of the present disclosure, and the computer program instructions are operable with a computer to execute corresponding operations implemented by the initiating terminal in various methods in embodiments of the present disclosure, which is not repeated herein for brevity.

Optionally, the computer program product is applicable to the relay terminal in embodiments of the present disclosure, and the computer program instructions are operable with a computer to execute corresponding operations implemented by the relay terminal in various methods in embodiments of the present disclosure, which is not repeated herein for brevity.

Optionally, the computer program product is applicable to the target terminal in embodiments of the present disclosure, and the computer program instructions are operable with a computer to execute corresponding operations implemented by the target terminal in various methods in embodiments of the present disclosure, which is not repeated herein for brevity. Embodiments of the present disclosure further provide a computer program.

Optionally, the computer program is applicable to the initiating terminal in embodiments of the present disclosure. The computer program, when executed by a computer, is operable to implement corresponding operations implemented by the initiating terminal in various methods in embodiments of the present disclosure, which is not repeated herein for brevity.

Optionally, the computer program is applicable to the relay terminal in embodiments of the present disclosure. The computer program, when executed by a computer, is operable to implement corresponding operations implemented by the relay terminal in various methods in embodiments of the present disclosure, which is not repeated herein for brevity.

Optionally, the computer program is applicable to the target terminal in embodiments of the present disclosure. The computer program, when executed by a computer, is operable to implement corresponding operations implemented by the target terminal in various methods in embodiments of the present disclosure, which is not repeated herein for brevity.

Those of ordinary skill in the art will appreciate that units and algorithmic operations of various examples described in connection with embodiments of the present disclosure can be implemented by electronic hardware or by a combination of computer software and electronic hardware. Whether these functions are performed by means of hardware or software depends on the application and the design constraints of the associated technical solution. Those skilled in the art can use different methods with regard to each particular application to implement the described functionality, but such methods should not be regarded as lying beyond the scope of the present disclosure.

It is evident to those skilled in the art that, for the sake of convenience and brevity, in terms of the specific working processes of the foregoing systems, apparatuses, and units, reference can be made to the corresponding processes in the foregoing method embodiments, which is not repeated herein.

It is appreciated that the systems, apparatuses, and methods disclosed in embodiments of the present disclosure can also be implemented in various other manners. For example, the above apparatus embodiments are merely illustrative, e.g., the division of units is only a division of logical functions, and other manners of division can be available in practice, e.g., multiple units or assemblies can be combined or can be integrated into another system, or some features can be ignored or skipped. In other respects, the coupling or direct coupling or communication connection as illustrated or discussed can be an indirect coupling or communication connection through some interface, device, or unit, and can be electrical, mechanical, or otherwise.

Separated units as illustrated can or cannot be physically separated. Components displayed as units can or cannot be physical units, and can reside at one location or can be distributed to multiple networked units. Some or all of the units can be selectively adopted according to practical needs to achieve desired objectives of the present disclosure.

In addition, various functional units described in various embodiments of the present disclosure can be integrated into one processing unit or can be present as a number of physically separated units, and two or more units can be integrated into one.

If the functions are implemented as software functional units and sold or used as standalone products, they can be stored in a computer-readable storage medium. Based on such an understanding, the essential technical solution, or the portion that contributes to the prior art, or part of the technical solution of the present disclosure can be embodied as software products. The computer software products can be stored in a storage medium and can include multiple instructions that, when executed, can cause a computer device, e.g., a personal computer, a server, a network device, etc., to execute some or all operations of the methods described in various embodiments of the present disclosure. The above storage medium can include various kinds of media that can store program codes, such as a universal serial bus (USB) flash disk, a mobile hard drive, an ROM, an RAM, a magnetic disk, or an optical disk.

The foregoing elaborations are merely implementations of the present disclosure, but are not intended to limit the protection scope of the present disclosure. Any variation or replacement easily thought of by those skilled in the art within the technical scope disclosed in the present disclosure shall belong to the protection scope of the present disclosure. Therefore, the protection scope of the present disclosure shall be subject to the protection scope of the claims.

What is claimed is:

1. A method for relay communication, comprising:
determining, by an initiating terminal according to whether a first target connection has been established between the initiating terminal and a relay terminal, whether to use the first target connection for communication between the initiating terminal and a target terminal.

2. The method of claim 1, wherein determining, by the initiating terminal according to whether the first target connection has been established between the initiating terminal and the relay terminal, whether to use the first target connection for communication between the initiating terminal and the target terminal comprises:
in a case where the first target connection has been established between the initiating terminal and the relay terminal, determining, by the initiating terminal, to use the first target connection for communication between the initiating terminal and the target terminal; or
in a case where the first target connection has not been established between the initiating terminal and the relay terminal, determining, by the initiating terminal, to establish the first target connection for communication between the initiating terminal and the target terminal.

3. The method of claim 1, further comprising:
in a case where the initiating terminal determines to use the first target connection for communication between the initiating terminal and the target terminal, transmitting, by the initiating terminal, a link modification request message to the relay terminal, wherein the link modification request message is used for requesting to use the first target connection for communication between the initiating terminal and the target terminal,
wherein the link modification request message contains at least one of: identity (ID) information of the target terminal or address information of the initiating terminal,
wherein the address information of the initiating terminal comprises media access control (MAC) address information of the initiating terminal,
wherein the ID information of the target terminal comprises a link layer ID of the target terminal.

4. The method of claim 3, further comprising:
receiving, by the initiating terminal, a link modification accept message from the relay terminal, wherein the link modification accept message indicates that the relay terminal determines to use the first target connection for communication between the initiating terminal and the target terminal,
wherein the link modification accept message contains address information of the target terminal,
wherein the address information of the target terminal comprises IP address information of the target terminal and/or MAC address information of the target terminal.

5. The method of claim 2, further comprising:
in a case where the initiating terminal determines to establish the first target connection, transmitting, by the initiating terminal, a second request message to the relay terminal, wherein the second request message is used for requesting to establish the first target connection.

6. The method of claim 5, further comprising:
transmitting, by the initiating terminal, address information of the initiating terminal to the relay terminal in a secure interaction procedure between the initiating terminal and the relay terminal.

7. The method of claim 5, further comprising:
receiving, by the initiating terminal, a second response message from the relay terminal, wherein the second response message indicates that establishment of the first target connection is completed,
wherein the second response message contains address information of the target terminal,
wherein the address information of the target terminal comprises IP address information of the target terminal and/or MAC address information of the target terminal.

8. An initiating terminal, comprising:
a transceiver;
a memory configured to store a computer program; and
a processor configured to execute the computer program to:
determine, according to whether a first target connection has been established between the initiating terminal and a relay terminal, whether to use the first target connection for communication between the initiating terminal and a target terminal.

9. The initiating terminal of claim 8, wherein the processor configured to determine according to whether the first target connection has been established between the initiating terminal and the relay terminal, whether to use the first target connection for communication between the initiating terminal and the target terminal is configured to:
in a case where the first target connection has been established between the initiating terminal and the relay terminal, determine to use the first target connection for communication between the initiating terminal and the target terminal; or
in a case where the first target connection has not been established between the initiating terminal and the relay terminal, determine to establish the first target connection for communication between the initiating terminal and the target terminal.

10. The initiating terminal of claim 8, wherein:
in a case where the processor determines to use the first target connection for communication between the initiating terminal and the target terminal, the transceiver is configured to transmit a link modification request message to the relay terminal, wherein the link modification request message is used for requesting to use the first target connection for communication between the initiating terminal and the target terminal,
wherein the link modification request message contains at least one of: identity (ID) information of the target terminal or address information of the initiating terminal,
wherein the address information of the initiating terminal comprises media access control (MAC) address information of the initiating terminal,
wherein the ID information of the target terminal comprises a link layer ID of the target

11. The initiating terminal of claim 10, wherein the transceiver is further configured to:
receive a link modification accept message from the relay terminal, wherein the link modification accept message indicates that the relay terminal determines to use the first target connection for communication between the initiating terminal and the target terminal;
wherein the link modification accept message contains address information of the target terminal,
wherein the address information of the target terminal comprises IP address information of the target terminal and/or MAC address information of the target terminal.

12. A relay terminal, comprising:
a transceiver;
a memory configured to store a computer program; and
a processor configured to execute the computer program to:
determine, according to whether a second target connection has been established between the relay terminal and a target terminal, whether to use the second target connection for communication between an initiating terminal and the target terminal.

13. The relay terminal of claim 12, wherein the processor configured to determine according to whether the second target connection has been established between the relay terminal and the target terminal, whether to use the second target connection for communication between the initiating terminal and the target terminal is configured to:
in a case where the second target connection has been established between the relay terminal and the target terminal, determine to use the second target connection for communication between the initiating terminal and the target terminal; or
in a case where the second target connection has not been established between the relay terminal and the target terminal, determine to establish the second target connection for communication between the initiating terminal and the target terminal.

14. The relay terminal of claim 12, wherein:
in a case where the relay terminal determines to use the second target connection for communication between the initiating terminal and the target terminal, the transceiver is configured to transmit a link modification request message to the target terminal, wherein the link modification request message is used for requesting to use the second target connection for communication between the initiating terminal and the target terminal,
wherein the link modification request message contains at least one of: identity (ID) information of the initiating terminal or address information of the initiating terminal,
wherein the address information of the initiating terminal comprises media access control (MAC) address information of the initiating terminal.

15. The relay terminal of claim 14, wherein the transceiver is further configured to:
receive a link modification accept message from the target terminal, wherein the link modification accept message indicates that the target terminal determines to use the second target connection for communication between the initiating terminal and the target terminal,
wherein the link modification accept message contains address information of the target terminal,
wherein the address information of the target terminal comprises IP address information of the target terminal and/or MAC address information of the target terminal.

16. The relay terminal of claim 12, wherein:
the transceiver is configured to receive a link modification request message from the initiating terminal, wherein the link modification request message is used for requesting to use a first target connection between the initiating terminal and the relay terminal for communication between the initiating terminal and the target terminal,
wherein the link modification request message contains ID information of the target terminal and/or address information of the initiating terminal,
wherein the address information of the initiating terminal comprises MAC address information of the initiating terminal,
wherein the ID information of the target terminal comprises a link layer ID of the target

17. The relay terminal of claim 16, wherein the transceiver is configured to transmit a link modification accept message to the initiating terminal, wherein the link modification accept message indicates that the relay terminal determines to use the first target connection for communication between the initiating terminal and the target terminal,
wherein the link modification accept message contains address information of the target terminal,
wherein the address information of the target terminal comprises IP address information of the target terminal and/or MAC address information of the target terminal.

18. The relay terminal of claim 12, wherein:
the transceiver is configured to receive a second request message from the initiating terminal, wherein the second request message is used for requesting to establish a first target connection between the initiating terminal and the relay terminal for communication between the initiating terminal and the target terminal.

19. The relay terminal of claim 18, wherein the processor is further configured to:
obtain address information of the initiating terminal in a secure interaction procedure between the relay terminal and the initiating terminal.

20. The relay terminal of claim 18, wherein:
the transceiver is configured to transmit a second response message to the initiating terminal, wherein the second response message indicates that establishment of the first target connection is completed,
wherein the second response message contains address information of the target terminal,
wherein the address information of the target terminal comprises IP address information of the target terminal and/or MAC address information of the target terminal.
